(19) United States
(12) Patent Application Publication
(10) Pub. No.: US 2007/0265031 A1
(43) Pub. Date: Nov. 15, 2007

(54) Mobile Phone, Display Method, and Computer Program

(75) Inventors: Michiaki Koizumi, Daito-shi (JP); Masahiro Konishi, Osaka-shi (JP); Kenji Kiyota, Shijonawate-shi (JP)

Correspondence Address: KRATZ, QUINTOS & HANSON, LLP, 1420 K Street, N.W., Suite 400, WASHINGTON, DC, 20005, US

(73) Assignee: SANDY ELECTRIC CO., LTD., Moriguchi-shi (JP)

(21) Appl. No.: 10/576,464

(22) PCT Filed: Oct. 19, 2004
(86) PCT No.: PCT/JP04/15761

§ 371 Date: Apr. 3, 2007

(30) Foreign Application Priority Data
Oct. 22, 2003 (JP) 2003-362310
Oct. 22, 2003 (JP) 2003-362309
Oct. 28, 2003 (JP) 2003-366952

(51) Int. Cl. H04M 1/00

(52) U.S. Cl. 455/556.1

(57) ABSTRACT

A mobile phone capable of displaying video and other information in a user-friendly manner without interrupting video display in the case where other information is displayed during the display of received video. The mobile phone, on receipt of an external event via a wireless unit during display by a display unit of video constituting a TV program received by a tuner, partitions a screen based on a partition ratio stored in a partition information storage unit, and displays both video constituting the TV program and information composed of information showing the occurrence of an external event, information related to an originator, and the like.

### TECHNICAL FIELD

The present invention relates to technology for displaying video and information on a mobile phone.

### BACKGROUND ART

Diversification of mobile phones has increased in recent years, with mobile phones having functions other than a call function continually appearing. These other functions includes, for example, Internet connectivity, email, audio/video (AV) email, and video calling.

With a conventional mobile phone, a currently operating function is interrupted before performing a subsequent function in the case where another function is activated while one of the functions is being used.

In this case, the screen displayed on the mobile phone changes from information related to the interrupted function to information related to the subsequent function.

For example, when an incoming email or call is received while the user is browsing a website with an Internet connection (i.e. Internet connectivity being used), the conventional mobile phone switches the screen displayed from information related to the website to information notifying the user that a call or email has been received.

However, the user may find it off-putting to have the display screen switched from information related to the current function to information related to the subsequent function when another function is activated with one of the functions currently in use. For this reason, users are calling for information related to other functions to be displayed without interrupting display of information related to the current function.

In view of this, an object of the present invention is to provide a mobile phone and a display method capable of displaying video and other information in a user-friendly manner without interrupting video display, in the case where other information is displayed during the display of received video.

### DISCLOSURE OF THE INVENTION

To achieve the above object, the present invention is a mobile phone for receiving a video signal and displaying video on a screen, and includes an acquiring unit operable to acquire incoming signal information related to an incoming signal or detection information related to detection of a prescribed operation by a user, a generating unit operable to generate display information related to mobile communication, and a display unit operable to generate downscaled video by downscaling the video being displayed on the screen relative to a size of the displayed video, and display the downscaled video and the display information respectively in a first display area and a second display area obtained by partitioning the screen in two.

According to this configuration, the mobile phone displays display information related to an incoming signal and video currently being displayed in different areas of the screen partitioned in two when incoming signal information or detection information is acquired, thereby enabling the display information to be notified to the user without interrupting video display on the screen.

For example, if an incoming call or email is received while video constituting a TV broadcast or video call is being displayed on the screen, the mobile phone is able to display information such as the telephone number of the caller or the email address of the sender related to the incoming call or email, without the display of video constituting the TV broadcast or video call being interrupted. Furthermore, if the mobile phone is constituted from an openable/closeable casing, and the opening of the casing by the user is detected while video constituting a TV broadcast or video call is being displayed with the casing in the closed state, the mobile phone is able to display information such as the telephone number of the caller or the email address of the sender related to the incoming call or email, without the display of video constituting the TV broadcast or video call being interrupted.

Here, the incoming signal information may include ID information identifying the originator, and the generating unit may generate the display information based on the ID information.

According to this configuration, the mobile phone displays the originator's ID information, being display information related to mobile communication, and video currently being displayed in different areas of the screen partitioned in two when incoming signal information is acquired, thereby enabling the display information to be notified to the user without interrupting video display on the screen.

For example, if an incoming call or email is received while video constituting a TV broadcast or video call is being displayed on the screen, the mobile phone is able to display information such as the telephone number of the caller or the email address of the sender related to the incoming call or email, without the display of video constituting the TV broadcast or video call being interrupted.

Here, the display unit may store ratio information showing an area ratio between the first display area and the second display area, and generate the downscaled video by downscaling the video based on the ratio information.

According to this configuration, the mobile phone generates downscaled video based on the stored ratio information, and is able to display the downscaled video in the first display region and the acquired ID information in the second display area. The mobile phone is thus able to display the ID information and video using a pre-stored area ratio.

Here, the mobile phone may further receive an audio signal corresponding to the video signal, and output audio, and the mobile phone may further include a volume adjusting unit operable to adjust a volume of the audio output on acquiring the incoming signal information, and an audio output unit operable to output or mute the audio based on the adjusted volume.

According to this configuration, the mobile phone is able to adjust the volume of audio output on receipt of an incoming signal during video display, and output or mute the audio based on the adjusted volume.

Here, the acquiring unit may acquire the detection information by detecting a prescribed operation by the user during video display in a standard video display orientation, and the display unit may generate downscaled/rotated video as the downscaled video by downscaling and rotating the video 90 degrees from the standard video display orientation, if the detection information is acquired.

According to this configuration, the mobile phone is able to generate downscaled/rotated video by downscaling and rotating the video 90 degrees, when a prescribed user operation is detected during video display on the screen, and display the display information on the screen alongside the downscaled/rotated video. The mobile phone is thus able to display the display information without interrupting video display when a prescribed operation is detected during video display. Furthermore, it is possible to display the display information while protecting the displayed video content at all times, by downscaling and rotating the displayed video 90 degrees from the standard video display orientation. Moreover, the user can easily view the displayed video, which is in portrait orientation on the screen when the user is operating the mobile phone.

Here, the display unit, on receipt of new ratio information showing an area ratio between a third display area different in size from the first display area and a fourth display area obtained by partitioning the screen in two, may upscale or further downscale the downscaled/rotated video based on the received ratio information, and display the downscaled/rotated video after upscaling or further downscaling in the third display area and the display information in the fourth display area.

According to this configuration, the mobile phone, by receiving ratio information different from the stored ratio information, is able to upscale or further downscale the downscaled/rotated video based on the received ratio information instead of displaying the display information on the screen alongside the downscaled/rotated video, and to display the display information alongside the downscaled/rotated video after upscaling or further downscaling.

Here, the mobile phone may further include an operation instruction receiving unit operable to receive an operation instruction from the user, a switching instruction receiving unit operable to receive a switching instruction from the user to switch an operation target, and an operation switching unit operable, on receipt of the switching instruction, to switch the target of an operation based on the operation instruction, from a first function relating to display of the downscaled/rotated video to a second function relating to the display information, or from the second function to the first function.

According to this configuration, the mobile phone, on receipt of a switching instruction from the user during display of the downscaled/rotated video and the display information on the screen, is able to switch the target of the operation based on the operating instruction. The user is thus able to operate the first function and the second function by switching the operation target.

Here, the operation switching unit may store output destination information showing one of the first function and the second function as the target of the operation based on the operation instruction, and rewrite the output destination information on receipt of the switching information, from information showing the first-function to information showing the second function, or from information showing the second function to information showing the first function, and the operation instruction receiving unit may output the operation instruction to one of the first function and the second function, according to information shown by the output destination information.

According to this configuration, the mobile phone, on receipt of a switching instruction from the user, rewrites the stored output destination information from information showing the first function to information showing the second function, or from information showing the second function to information showing the first function, and the operation instruction receiving unit is able to output the operation instruction to one of the first function and the second function according to information shown by the output destination information. The operation target can thus be switched.

Here, the mobile phone may further receive an audio signal corresponding to the video signal, and output audio, and the mobile phone may further include an operating instruction receiving unit operable to receive an operating instruction relating to the mobile phone, a volume adjusting unit operable to adjust the volume of the audio output on receipt of the operating instruction, and an audio output unit operable to output or mute the audio based on the adjusted volume.

According to this configuration, the mobile phone is able to adjust the volume of audio output on receipt of an operating instruction from the user, and output or mute the audio based on the adjusted volume.

Here, the mobile phone may further include two speakers disposed one on either side of the screen, and an audio output unit operable to play audio included in a television broadcast signal in stereo using the two speakers when the two speakers are positioned laterally relative to the video, and in monaural using the two speakers when the two speakers are positioned vertically relative to the video.

According to this configuration, audio is output in stereo if the speakers are positioned laterally (i.e. on the left/right) relative to the displayed video as seen from the user, thereby enabling the user to enjoy the audio in stereo, whereas audio is output in monaural from at least one of the speakers if the speakers are vertically positioned (i.e. a direction other than the lateral direction) relative to the displayed video, thereby enabling the user to listen to the sound without experiencing the unnaturalness and difficulty in hearing associated with listening to the right channel of stereo audio coming from above the video and the left channel of stereo audio coming from below the video.

A display method of the present invention is used by a mobile phone that receives a video signal, displays video on a screen, and includes an acquiring unit, a generating unit and a display unit. The display method includes the steps of using the acquiring unit to acquire incoming signal information related to an incoming signal or detection information related to detection of a prescribed operation by a user, using the generating unit to generate display information related to mobile communication, and using the display unit to generate downscaled video by downscaling the video being displayed on the screen relative to a size of the displayed video, and display the downscaled video and the display information respectively in a first display area and a second display area obtained by partitioning the screen in two.

According to this configuration, the mobile phone displays display information related to an incoming signal and video currently being displayed in different areas of the screen partitioned in two when incoming signal information or detection information is acquired, thereby enabling display information to be notified to the user without interrupting video display on the screen.

For example, if an incoming call or email is received while video constituting a TV broadcast or video call is being displayed on the screen, the mobile phone is able to display information such as the telephone number of the caller or the email address of the sender related to the incoming call or email, without the display of video constituting the TV broadcast or video call being interrupted. Furthermore, if the mobile phone is constituted from an openable/closeable casing, and the opening of the casing by the user is detected while video constituting a TV broadcast or video call is being displayed with the casing in the closed state, the mobile phone is able to display information such as the telephone number of the caller or the email address of the sender related to the incoming call or email, without the display of video constituting the TV broadcast or video call being interrupted.

Here, the incoming signal information may include ID information identifying an originator, and the generating step may generate the display information based on the ID information.

According to this configuration, the mobile phone displays the originator's ID information, being display information related to mobile communication, and video currently being displayed in different areas of the screen partitioned in two when information related to an incoming signal or information related to an operation by the user is acquired, thereby enabling the display information to be notified to the user without interrupting video display on the screen.

For example, if an incoming call or email is received while video constituting a TV broadcast or video call is being displayed on the screen, the mobile phone is able to display information such as the telephone number of the caller or the email address of the sender related to the incoming call or email, without the display of video constituting the TV broadcast or video call being interrupted.

Here, the acquiring step may use the acquiring unit to acquire the detection information by detecting a prescribed operation by the user during video display in a standard video display orientation, and the display step may use the display unit to generate downscaled/rotated video as the downscaled video by downscaling and rotating the video 90 degrees from the standard video display orientation, if the detection information is acquired.

According to this configuration, the mobile phone is able to generate downscaled/rotated video by downscaling and rotating the video 90 degrees, when a prescribed user operation is detected during video display on the screen, and display the display information on the screen alongside the downscaled/rotated video. The mobile phone is thus able to display the display information without interrupting video display when a prescribed operation is detected during video display. Furthermore, it is possible to display the display information while protecting the displayed video content at all times, by downscaling and rotating the displayed video 90 degrees from the standard video display orientation. Moreover, the user can easily view the displayed video, which is in portrait orientation on the screen when the user is operating the mobile phone.

Here, the mobile phone may further include two speakers disposed one on either side of the screen, and an audio output unit, and the display method may further include the step of using the audio output unit to play audio included in a television broadcast signal in stereo using the two speakers when the two speakers are positioned laterally relative to the video, and in monaural using the two speakers when the two speakers are positioned vertically relative to the video.

According to this configuration, audio is output in stereo if the speakers are positioned laterally (i.e. on the left/right) relative to the displayed video as seen from the user, thereby enabling the user to enjoy the audio in stereo, whereas audio is output in monaural from at least one of the speakers if the speakers are vertically positioned (i.e. a direction other than the lateral direction) relative to the displayed video, thereby enabling the user to listen to the sound without experiencing the unnaturalness and difficulty in hearing associated with listening to the right channel of stereo audio coming from above the video and the left channel of stereo audio coming from below the video.

A computer program of the present invention is applied in a mobile phone that receives a video signal, displays video on a screen, and includes an acquiring unit, a generating unit and a display unit. The computer program causes a computer to execute the steps of using the acquiring unit to acquire incoming signal information related to an incoming signal or detection information related to detection of a prescribed operation by a user, using the generating unit to generate display information related to mobile communication, and using the display unit to display the incoming signal information or the display information.

According to this configuration, the mobile phone displays display information related to an incoming signal and video currently being displayed in different areas of the screen partitioned in two when incoming signal information or detection information is acquired, thereby enabling display information to be notified to the user without interrupting video display on the screen.

For example, if an incoming call or email is received while video constituting a TV broadcast or video call is being displayed on the screen, the mobile phone is able to display information such as the telephone number of the caller or the email address of the sender related to the incoming call or email, without the display of video constituting the TV broadcast or video call being interrupted. Furthermore, if the mobile phone is constituted from an openable/closeable casing, and the opening of the casing by the user is detected while video constituting a TV broadcast or video call is being displayed with the casing in the closed state, the mobile phone is able to display information such as the telephone number of the caller or the email address of the sender related to the incoming call or email, without the display of video constituting the TV broadcast or video call being interrupted.

Here, the incoming signal information may include ID information identifying an originator, and the generating step may generate the display information based on the ID information.

According to this configuration, the mobile phone is able to display ID information identifying the originator and video in different areas of the screen partitioned in two, when an incoming signal is received during video display on the screen. The mobile phone is thus able to notify the user that an incoming call or email has been received during video display, without interrupting the video display.

Here, the acquiring step may use the acquiring unit to acquire the detection information by detecting a prescribed operation by the user during video display in a standard video display orientation, and the display step may use the display unit to generate downscaled/rotated video as the downscaled video by downscaling and rotating the video 90 degrees from the standard video display orientation, if the detection information is acquired.

According to this configuration, the mobile phone is able to generate downscaled/rotated video by downscaling and rotating the video 90 degrees, when a prescribed user operation is detected during video display on the screen, and display the display information on the screen alongside the downscaled/rotated video. The mobile phone is thus able to display the display information without interrupting video display when a prescribed operation is detected during video display. Furthermore, it is possible to display the display information while protecting the displayed video content at all times, by downscaling and rotating the displayed video 90 degrees from the standard video display orientation. Moreover, the user can easily view the displayed video, which is in portrait orientation on the screen when the user is operating the mobile phone.

Here, the mobile phone may further include two speakers disposed one on either side of the screen, and an audio output unit, and the computer program may further cause the computer to execute the step of using the audio output unit to play audio included in a television broadcast signal in stereo using the two speakers when the two speakers are positioned laterally relative to the video, and in monaural using the two speakers when the two speakers are positioned vertically relative to the video.

According to this configuration, audio is output in stereo if the speakers are positioned laterally (i.e. on the left/right) relative to the displayed video as seen from the user, thereby enabling the user to enjoy the audio in stereo, whereas audio is output in monaural from at least one of the speakers if the speakers are vertically positioned (i.e. a direction other than the lateral direction) relative to the displayed video, thereby enabling the user to listen to the sound without experiencing the unnaturalness and difficulty in hearing associated with listening to the right channel of stereo audio coming from above the video and the left channel of stereo audio coming from below the video.

### BRIEF DESCRIPTION OF THE DRAWINGS

FIGS. 1A & 1B are perspective views of a mobile phone pertaining to an embodiment 1 of the present invention;

FIG. 2 shows a form of use when watching TV with the mobile phone in a closed state;

FIG. 3 is a block diagram showing a configuration of the mobile phone;

FIG. 4 shows the data structure of a partition information table stored in a partition information storage unit;

FIG. 5 shows the data structure of a volume information table stored in a volume information storage unit;

FIG. 6 shows the data structure of a telephone book table stored in a telephone book storage unit;

FIGS. 7A & 7B show forms of display when the screen is partitioned;

FIG. 8 is a flowchart showing TV program output processing;

FIG. 9 is a flowchart showing display control switch processing;

FIG. 10 is a flowchart showing event notification processing;

FIG. 11 is a flowchart showing notification information generation processing;

FIG. 12 is a flowchart showing key operation switch processing;

FIG. 13 is a flowchart showing volume adjustment processing;

FIGS. 14A & 14B are schematics of a mobile phone pertaining to an embodiment 2 of the present invention;

FIGS. 15A & 15B shows the mobile phone displaying a received TV broadcast on a display unit;

FIG. 16 is a block diagram showing an internal configuration of the mobile phone;

FIG. 17 is a flowchart showing audio mode judgment processing; and

FIGS. 18A & 18B are schematics of a mobile phone with a rotating structure.

### BEST MODE FOR CARRYING OUT THE INVENTION

### Embodiment 1

A mobile phone 1 is described below as an embodiment pertaining to the present invention.

1. Overview of Mobile Phone 1

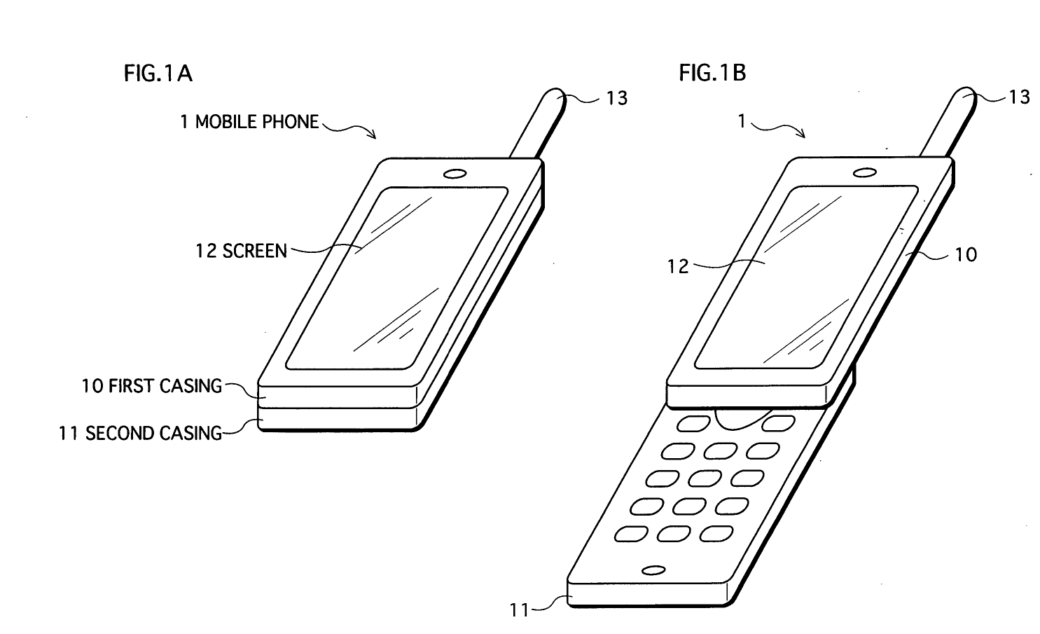

An overview of mobile phone 1 is given here. Mobile phone 1, which is a sliding phone having a TV function for receiving and outputting TV programs, is composed of a first casing 10 and a second casing 11, as shown in FIGS. 1A and 1B. The user is able to carry mobile phone 1 with first casing 10 overlapping second casing 11 (hereinafter “closed state” or simply “closed”), as shown in FIG. 1A, and is able to use functions provided in mobile phone 1 by sliding second casing 11 longitudinally, as shown in FIG. 1B, to extend mobile phone 1 (hereinafter “open state” or simply “open”). Here, the connecting and disconnecting of power to mobile phone 1 is performed in the open state.

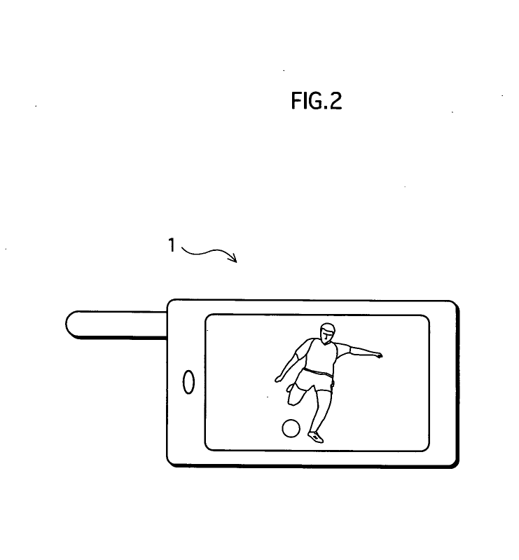

To watch a TV program on mobile phone 1, the user firstly performs a prescribed operation by pressing a button with mobile phone 1 in the open state to instruct mobile phone 1 to start receiving the TV program. The user can then watch the TV program in the closed state by transferring mobile phone 1 from the open to the closed state. In this case, mobile phone 1 displays video constituting the TV program with an LCD screen 12 in landscape orientation (i.e. horizontally long), as shown in FIG. 2. The standard TV screen, in terms of width and height, is wider than it is tall (standard aspect ratio of 4:3). Thus, by turning the screen for displaying video that constitutes the TV program sideways, the user is able to watch TV programs on mobile phone 1 with a feel similar to a standard TV.

Note that a button (not depicted) may be installed on the side of mobile phone 1, and TV program reception instructed by depressing this button when mobile phone 1 is closed. Also, while an aspect ratio of 4:3 is preferable when displaying TV programs on mobile phone 1, the aspect ratio is not limited this. The aspect ratio may take other values, provided the width is greater than the height.

When an external event (e.g. incoming email or call) is received during the display of video constituting a TV program in the closed state, mobile phone 1 partitions the screen horizontally in two, and displays video constituting the TV program in one of the partitioned areas, while using the other area of the screen to notify the user that an event has occurred. Also, on detecting that the user has activated another function during the display of video constituting the TV program in the closed state, mobile phone 1 partitions the screen horizontally in two with the screen in portrait orientation (i.e. vertically long). Furthermore, video constituting the TV program is downscaled in size in comparison to normal display, so that the video can be displayed in one of the partitioned areas of the screen. The downscaled video is then displayed in one of the partitioned area, while in the other area of the screen is displayed information for displaying a standby screen displayed at all times when mobile phone 1 is not in use, or information resulting from another function.

Note that in the present embodiment, an “external event” refers to an incoming email or call, and that “reception of an external event” refers to reception of an incoming email or call. Also, “incoming call” includes calls related to video calling, and “incoming email” includes AV email.

2. Configuration of Mobile Phone 1

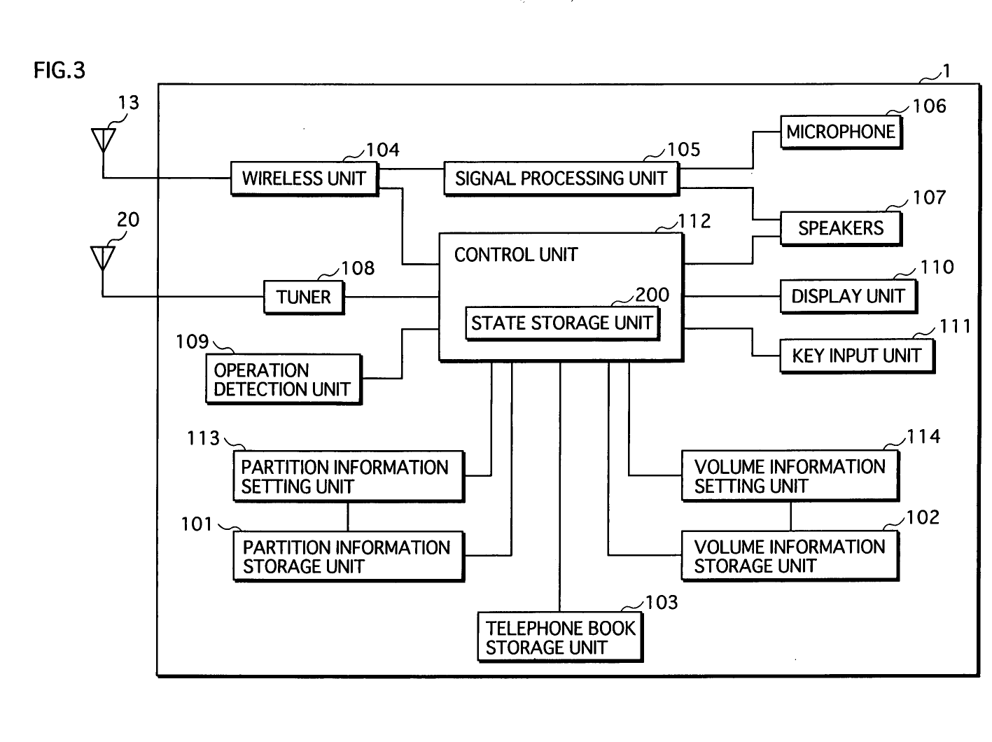

The configuration of mobile phone 1 is described here. Mobile phone 1, as shown in FIG. 3, is constituted from a partition information storage unit 101, a volume information storage unit 102, a telephone book storage unit 103, a wireless unit 104, a signal-processing unit 105, a microphone 106, speakers 107, a tuner 108, an operation detection unit 109, a display unit 110, a key input unit 111, a control unit 112, a partition-information setting unit 113, and a volume-information setting unit 114.

Mobile phone 1 is, specifically, a computer system constituted from a microprocessor, a ROM, a RAM, and a display unit etc. Computer programs are stored in the ROM, and mobile phone 1 functions as a result of the microprocessor operating in accordance with the computer programs.

Furthermore, mobile phone 1, which performs the normal operations of a mobile phone, also has additional constituent elements not depicted in the figures, such a clock unit with a clock function, a memory unit storing a Japanese input function etc., and a power supply unit that has a rechargeable secondary battery and a power supply circuit etc., and supplies power to the various constituent elements.

(1) Partition Information Storage Unit 101

Partition information storage unit 101 stores ratios for partitioning the screen, in correspondence with the open/closed state of mobile phone 1.

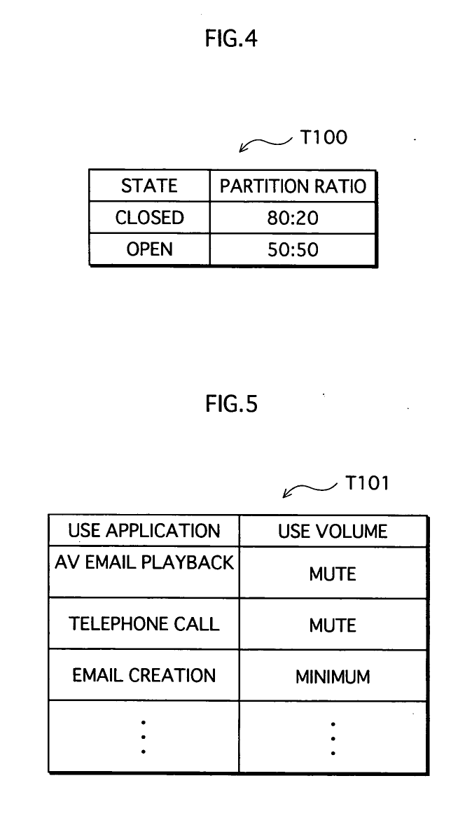

Partition information storage unit 101 has a partition information table T100, an example of which is shown in FIG. 4. Partition information table T100 is provided with an area for storing two sets each composed of a “state” and a “partition ratio”.

A state is information showing the open/closed state of mobile phone 1. A partition ratio, when partitioning the screen horizontally, is information showing a ratio between an upper screen area and a lower screen area. That is, the partition ratios each show an area ratio between the upper and lower screen areas. The partition ratio “A:B” indicates that the percentages of the upper and lower screen areas are respectively “A” and “B” when partitioning the screen.

For example, if the partition ratio in the CLOSED state is “80:20”, mobile phone 1 partitions the screen in the closed state at 80% and 20% for the upper and lower screen areas, respectively.

Note that the partition ratios for the OPEN and CLOSED states are already pre-stored in partition information table T100 at the time mobile phone 1 is purchased.

(2) Volume Information Storage Unit 102

Volume information storage unit 102 stores TV program volumes for output when other functions are used during the display of video constituting a TV program on mobile phone 1, in correspondence with the application of the other functions.

Volume information storage unit 102 has a volume information table T101, an example of which is shown in FIG. 5. Volume information table T101 is provided with an area for storing one or more sets each composed of a “use application” and a “use volume”. Note that these sets composed of use applications and use volumes are hereinafter referred to as “volume information”.

A use application is information showing the use application of another function used during the display of video constituting a TV program.

A use volume is information showing the audio volume of a TV program output when an operation shown by the use application is performed. Here, “mute” indicates that that the audio of the TV program is not output, and “minimum” indicates that the audio is output at minimum volume.

For example, if the use application is “AV email playback” and the use volume is “mute”, the audio of the TV program is not output.

(3) Telephone Book Storage Unit 103

Telephone book storage unit 103 stores the names of friends, acquaintances, and associates of the user of mobile phone 1, in correspondence with their respective telephone numbers and email addresses.

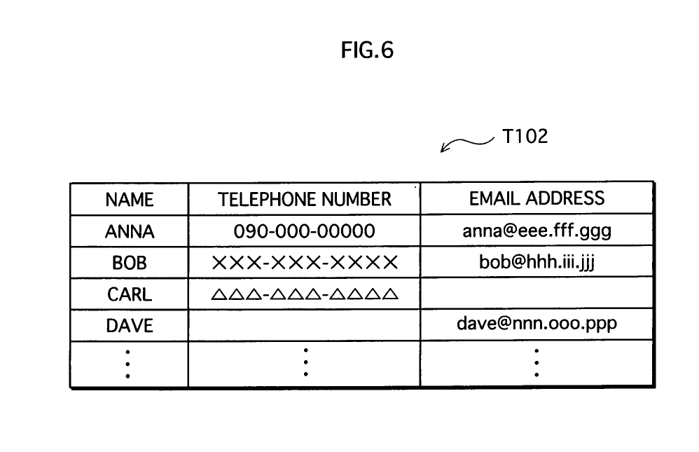

Telephone book storage unit 103 has a telephone book table T102, an example of which is shown in FIG. 6. Telephone book table T102 is provided with an area for storing one or more sets each composed of a name, a telephone number, and an email address.

The names are the names of friends, acquaintances, and associates of the user of mobile phone 1, the telephone numbers are their telephone numbers, and the email addresses are their email addresses.

Note that the names need not be corresponded to both the telephone numbers and email addresses, and may be corresponded to either the telephone numbers or email addresses.

(4) Wireless Unit 104

Wireless unit 104 modulates signals transmitted and received via an antenna 13.

(5) Signal-Processing Unit 105

Signal-processing unit 105 performs processing to transmit audio signals input from microphone 106 via wireless unit 104, and processing to output audio signals received from antenna 13 via wireless unit 104 to speakers 107.

Furthermore, when a signal related to an incoming email/AV email or call is received via wireless unit 104, signal-processing unit 105 performs processing to output the received signal to control unit 112. Also, when a signal related to an outgoing email/AV email or call is received from control unit 112, signal-processing unit 105 performs processing to transmit the received signal via wireless unit 104.

(6) Microphone 106

Microphone 106 outputs input audio to signal-processing unit 105 as audio signals.

(7) Speakers 107

Speakers 107 output audio signals processed by signal-processing unit 105 and audio data received from control unit 112 as audio.

(8) Tuner 108

Tuner 108 is provided with an antenna 20. When an instruction to receive a specific TV program is received from control unit 112, tuner 108 receives the broadcast waves of digital TV broadcasts from a plurality of broadcast stations, and selects the broadcast wave corresponding to the specific TV program from the plurality of received broadcast waves. Furthermore, tuner 108 acquires the TV program from the selected broadcast wave, and outputs the acquired TV program to control unit 112. Here, TV programs are composed of video data and-audio data, and are specifically signals based on the MPEG4 (Moving Pictures Experts Group 4) standard, as well as JPEG2000, H263, and MPEG2 standards.

Tuner 108 ends reception of the plurality of broadcast waves when an instruction to end TV program reception is received from control unit 112.

(9) Operation Detection Unit 109

Operation detection unit 109 detects the open/closed state of mobile phone 1.

Operation detection unit 109 has an open/close switch that is connected or disconnected depending on the open/closed state of mobile phone 1. The switch is connected allowing an electronic signal to pass when mobile phone 1 is open, and disconnected preventing the electronic signal from passing when mobile phone 1 is closed. Note that the electronic signal flows constantly through the switch when mobile phone 1 is open.

Operation detection unit 109 outputs open/close information to control unit 112 showing that mobile phone 1 is open, when transition from the closed to the open state (i.e. electronic signal has started flowing through the open/close switch) is detected. Also, operation detection unit 109 outputs open/close information to control unit 112 showing that mobile phone 1 is closed, when transition from the open to the closed state (i.e. electronic signal has stopped flowing through the open/close switch) is detected.

The use of functions provided in mobile phone 1 can thus be detected, since mobile phone 1 firstly needs to be opened when functions are used.

(10) Display Unit 110

Display unit 110 displays video data received as video from control unit 112 and information received from control unit 112 on screen 12.

The following two scenarios are given here in the case where display is performed after partitioning screen 12. One involves an external event occurring during the display of video constituting a TV program when mobile phone 1 is closed, and the other involves mobile phone 1 being opened during the display of video constituting a TV program. Display with screen 12 partitioned is described below for each of these scenarios, with mobile phone 1 closed in the former and open in the latter.

(A) Closed State

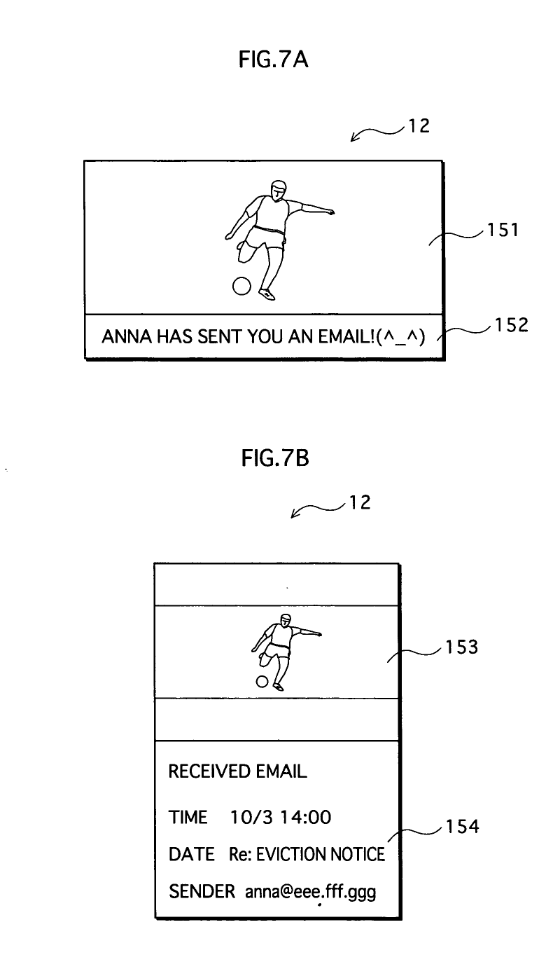

When mobile phone 1 is closed, screen 12 is partitioned into a first screen 151 and a second screen 152, an example of which is shown in FIG. 7A. Control unit 112 controls the partitioning at this time.

Display unit 110 receives the video data of the TV program, and notification information composed of information showing that an external event has occurred and information related to the originator. Display unit 110 displays the received video data of the TV program as video on first screen 151, and displays the received notification information on second screen 152. In other words, video constituting the TV program is displayed after being downscaled to be displayable on first screen 151.

Here, the notification information is composed of information showing an incoming email and information related to the sender (e.g. sender's name or email address) in the case of an email being received, and information showing an incoming call and information related to the caller (e.g. caller's name or telephone number) in the case of a call being received.

(B) Open State

When mobile phone 1 is open, screen 12 is partitioned into a third screen 153 and a fourth screen 153, an example of which is shown in FIG. 7B. Control unit 112 controls the partitioning at this time.

Display unit 110 receives the video data of the TV program and information for display. Here, “information for display” is information displayed according the operational state of mobile phone 1. The “operational state” refers to one of standby for an incoming call or email, receiving a call, making a call, receiving an email, and sending an email. In other words, the information for display shows the operational state of mobile phone 1 immediately after moving from the closed to the open state, this being one of the following: information displayed as a standby screen when mobile phone 1 is on standby for an incoming call or email; information notifying the user of an incoming call when a call is received; information indicating the placing of a call when a call is made; information notifying the user of an incoming email when an email is received; or information indicating the transmission of an email when an email is sent. After moving from a closed to an open state, mobile phone 1 performs one of the above operations, and displays information corresponding to the performed operation. After displaying this information, control unit 112 controls the transition to another screen that results from a user operation. For example, this may involve the transition from the standby screen to a screen displaying the telephone book. Note that, hereinafter, information for display and information related to a screen displayed as the result of a screen transition is referred to as “display information”. In other words, display information indicates one of information for display and information related to a screen displayed as the result of a screen transition.

Display unit 110 displays the received video data of the TV program as video on third screen 153, and displays the received display information on fourth screen 154. In other words, display unit 110 displays video constituting the TV program downscaled to be displayable on third screen 153. At this time, top and bottom portions of third screen 153 are non-display areas, the size of which depends on the aspect ratio of third screen 153. Also, in FIG. 7B, display information on receipt of an incoming email is shown as exemplary display information displayed on fourth screen 154.

(11) Key Input Unit 111

Key input unit 111 performs operations related to the operating instructions of functions provided in mobile phone 1, such as telephoning, data input, and data transmission.

Key input unit 111, on receipt of an operating instruction as the result of a key operation by the user, outputs operating instruction information corresponding to the received operating instruction to control unit 112.

Key input unit 111, on receipt of an instruction to start TV viewing as the result of a key operation by the user, outputs viewing start information to control unit 112 requesting TV program reception. Also, on receipt of an instruction to end TV viewing as the result of a key operation by the user, key input unit 111 outputs viewing end information to control unit 112 to end TV program reception.

Key input unit 111, on receipt of partition information showing a partition ratio for partitioning the screen as the result of a key operation by the user, outputs the received partition information to control unit 112. Here, the partition information is composed of a partition ratio and a state type showing the open/closed state of mobile phone 1. The state type shows one of “closed” and “open”.

Key input unit 111, on receipt of volume registration information composed of volume information and a registration type showing the registration type of the volume information as the result of a key operation by the user, outputs the received volume registration information to control unit 112. The registration type shows one of “new registration of volume information” and “change in volume information”.

Key input unit 111, on receipt of an instruction to switch the allocation of key operations as the result of a key operation by the user when partitioning the screen, outputs switching instruction information to control unit 112.

(12) Control Unit 112

Control unit 112 controls the overall operations of mobile phone 1, and is provided with a state memory unit 200 for storing one of closed state information and open state information. Note that when power is applied to mobile phone 1, open state information is stored in state memory unit 200 as default information.

Control unit 112, on receipt of partition information from key input unit 111, outputs the received partition information to partition-information setting unit 113.

Control unit 112, on receipt of volume registration information from key input unit 111, outputs the received volume registration information to volume-information setting unit 114.

Control unit 112, on receipt of a TV program from tuner 108, separates the received TV program into video data and audio data, and outputs the video data to display unit 110 and the audio data to speakers 107. Furthermore, control unit 112, on receipt of viewing end information from key input unit 111, outputs an end reception instruction to tuner 108.

Control unit 112, on receipt of switching instruction information from key input unit 111 during display of video constituting the TV program by display unit 110 in the closed state, judges whether key operations on information currently shown on the third screen are enabled (i.e. whether key operations on the TV function are enabled). If judged that key operations on the TV function are enabled, control unit 112 disables key operations on the TV function, enables key operations on information displayed on fourth screen 154, and controls operations on functions related to information displayed on fourth screen 154 based on operating instruction information received from key input unit 111. For example, if information concerning the standby screen is displayed on fourth screen 154, control unit 112 enables key operations usable during display of the standby screen, and controls operations during display of the standby screen. Alternatively, if information concerning the email creation screen is displayed on fourth screen 154, control unit 112 enables key operations related to email creation, and controls operations related to email creation. If judged that the TV function is not enabled (i.e. that key operations on information shown on fourth screen 154 are enabled), control unit 112 disables key operations on information displayed on fourth screen 154, enables key operations on the TV function, and controls operations on the TV function based on operating instruction information received from key input unit 111. Control unit 112 is thus able to switch the allocation of key operations during split-screen display.

Furthermore, control unit 112, on receipt of an operating instruction relating to another function (e.g. call start instruction, playback instruction related to an AV email, email creation start instruction, etc.) during display of video constituting the TV program by display unit 110 in the open state, judges whether volume information that includes a use application corresponding to the received operating instruction exists in volume information table T101. If judged that the relevant volume information exists, control unit 112 acquires this volume information, and acquires a use volume included in the acquired volume-information. Control unit 112 controls the audio volume of TV program output from speakers 107 based on the acquired use volume. If audio data is obtained from the other function, control unit 112 also outputs this audio data to speakers 107.

Here, the operations of control unit 112 at the start of TV viewing, as well as when the open/closed state has changed during display of video constituting a TV program by display unit 110 and when an external event has been received during display of video constituting a TV program by display unit 110, are described below.

(A) Start of TV Viewing

Control unit 112, on receipt of viewing start information from key input unit 111, outputs the reception start instruction to tuner 108, and judges whether the information stored in state storage unit 200 is open state information or closed state information. If judged to be open state information, control unit 112 generates display information corresponding to the current operating condition. For example, if mobile phone 1 is currently displaying the standby screen while waiting for an incoming call, the display information shows the standby screen.

Next, control unit 112 controls display unit 110 to perform display with screen 12 partitioned into third screen 153 and fourth screen 154 based on the partition ratio corresponding to the open state in partition information table T100 stored in partition information storage unit 101. Control unit 112 then outputs the video data of the TV program and the generated display information to display unit 110.

If judged that closed state information is stored in state storage unit 200, control unit 112 controls display unit 110 to display the video data of the TV program as video with screen 12 in landscape orientation, and outputs the video data of the TV program to display unit 110.

(B) Change in Open/Closed State

Control unit 112, on receipt of open state information or closed state information from operation detection unit 109 during output of a TV program (i.e. during output of video data to display unit 110), updates the information stored in state storage unit 200 to the received information. Furthermore, control unit 112 judges whether the received information is open state information or closed state information.

If judged that the received information is closed state information, control unit 112 converts the arrangement of the video data so that video is rotated 90 degrees to the right for display, controls display unit 110 to display the video data of the TV program as video with screen 12 in landscape orientation, and outputs the video data of the TV program to display unit 110. In other words, display unit 110 displays video that has been rotated 90 degrees to the right, and also upscaled for display using the whole area of screen 12 in comparison to video displayed using the third screen area of screen 12.

If judged that the received information is open state information, control unit 112 generates display information corresponding to the current operating condition. Next, control unit 112 converts the arrangement of the video data so that video is rotated 90 degrees to the left for display, controls display unit 110 to display video constituting the TV program and display information, with screen 12 partitioned into third screen 153 and fourth screen 154 based on the partition ratio corresponding to the open state in partition information table T100 stored in partition information storage unit 101, and outputs the video data of the TV program and the generated display information to display unit 110. In other words, display unit 110 displays video that has been rotated 90 degrees to the left, and also downscaled for display using the area of the third screen of screen 13 in comparison to video displayed using the whole area of screen 12.

Here, 90-degree rotation is given below as an example. Video data is usually composed of a plurality of pixels, and constituted from an area that is m pixels wide×n pixels high (e.g. m=176, n=144). The position of the pixels is shown by (x,y). For example, the pixel shown by (1,1) is positioned at the top left corner of the area, the pixel shown by (176,1) is positioned at the top right corner of the area, the pixel shown by (1,144) is positioned at the bottom left corner of the area, and the pixel shown by (176,144) is positioned at the bottom right corner of the area. An area is secured for storing rotated video data. Next, when rotating video 90 degrees to the right, the pixel positioned at (x,y) is copied to the position shown by (V-y+1,x) of the secured area. Note that V is the number of pixels in the vertical direction after rotation. Doing this for all of the pixels enables video for display to be rotated 90 degrees to the right. When rotating video 90 degrees to the left, the pixel positioned at (x,y) is copied to a position shown by (y, H-x+1) of the secured area. Note that H is the number of pixels in the horizontal direction after rotation. Doing this for all of the pixels enables video for display to be rotated 90 degrees to the left.

An example is given here in which video for display is upscaled/downscaled. Video data is usually composed of a plurality of pixels, and constituted from an area that is m pixels wide×n pixels high (e.g. m=176, n=144). When upscaling/downscaling video for display, an area for storing upscaled/downscaled video data is secured, and a height ratio p and a width ratio q are calculated for the screen size being displayed and the screen size after upscaling/downscaling. Next, the pixel shown by (x,y) is copied to (xp,yq) of the secured area. Values of xp and yq after the decimal point are rounded. Doing this for all of the pixels enables video for display to be upscaled/downscaled.

(C) Reception of External Event

Control unit 112, on receipt of an external event via wireless unit 104 during output of a TV program (i.e. during display of video data by display unit 110), judges whether the received event is an incoming call or an incoming email.

If judged that the received event is an incoming call, control unit 112 acquires the originator's telephone number from information related to the received call, and judges whether the name of the originator corresponding to the acquired telephone number exists in telephone book table T102. Control unit 112 uses the originator's name to generate notification information notifying the user of the incoming call if judged to exist, and uses the acquired telephone number to generate notification information notifying to user of the incoming call if judged not to exist. Note that if the originator's telephone number cannot be acquired due to non-notification, information indicating the non-notification is used instead of a telephone number to generate notification information.

If judged that the received event is an incoming email, control unit 112 acquires the originator's email address from information related to the received email, and judges whether the name of the originator corresponding to the acquired address exists in telephone book table T102. Control unit 112 uses the originator's name to generate notification information notifying the user of the incoming email if judged to exist, and uses the acquired email address to generate notification information notifying to user of the incoming email if judged not to exist. For example, if the originator's email address acquired from information related to the received email is “anna@eee.fff.ggg”, control unit 112 generates notification information using the name “Anna” registered in telephone book table T102, while if the originator's email address acquired from information related to the received email is “zane@eee.fff.ggg”, control unit 112 generates notification information using the acquired email address.

Next, control unit 112 judges whether the information stored in state storage unit 200 is open state information or closed state information. If judged to be closed state information, control unit 112 controls display unit 110 to display video constituting the TV program and the notification information, with screen 12 partitioned into first screen 151 and second screen 152 based on the partition ratio corresponding to the closed state in partition information table T100 stored in partition information storage unit 101, and outputs the video data of the TV program and the notification information to display unit 110. In other words, display unit 110 displays video downscaled for display using the first screen area of screen 12, in comparison to display performed using the whole area of screen 12.

If judged that the stored information is open state information, control unit 112 outputs the video data of the TV program and the notification information as display information to display unit 110. Needless to say, control unit 112 controls display unit 110 at this time to perform display with screen 12 partitioned.

(13) Partition-Information Setting Unit 113

Partition-information setting unit 113, on receipt of partition information from control unit 112, updates the partition ratios in partition information table T100 based on the state type included in the received partition information.

For example, if the state type and partition ratio included in the received partition information are respectively “closed” and “60:40”, the partition ratio corresponding to the closed state in partition information table T100 is updated from “50:50” to “60:40”.

The partition ratios pre-stored in mobile phone 1 at the time of purchase can thus be updated.

(14) Volume-Information Setting Unit 114

Volume-information setting unit 114, on receipt of volume registration information from control unit 112, newly registers or changes volume information in volume information table T101 based on the registration type included in the received volume information.

For example, if the registration type included in the received volume information shows “new registration”, the volume information included in the received volume information is written into volume information table T101. Alternatively, if the registration type included in the received volume information shows “change”, the volume information in volume information table T101 is changed based on the volume information included in the received volume information.

Volume information can thus be updated or changed.

3. Operations of Mobile Phone 1

The operations of mobile phone 1 are described here.

(1) TV Program Output

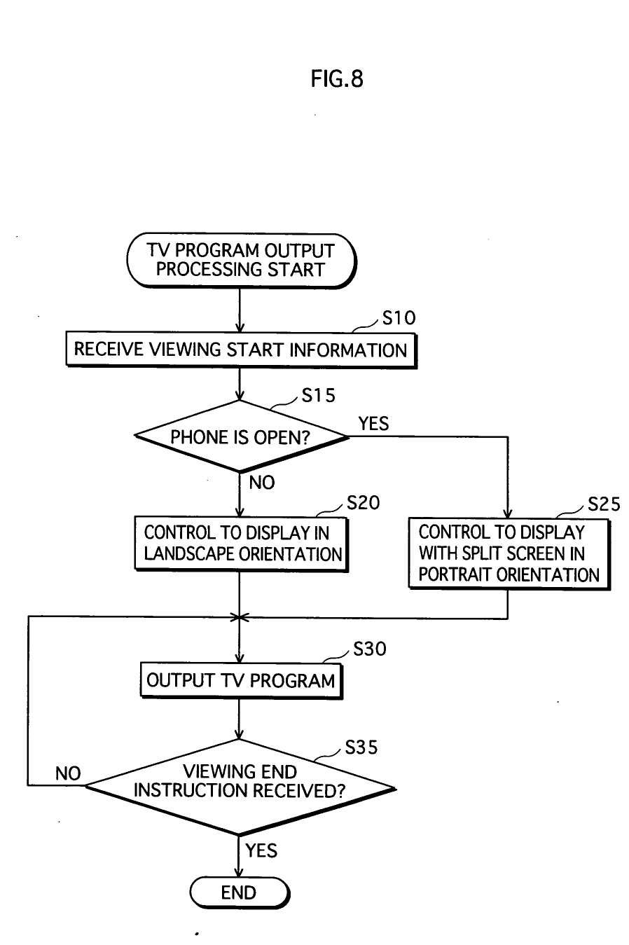

The output of a TV program is described here, using the flowchart shown in FIG. 8.

Control unit 112, on receipt of viewing start information from key input unit 111 as the result of a key operation by the user (step S10), judges whether the information stored in state storage unit 200 is open state information or closed state information (step S15).

If judged not to be open state information, indicating that mobile phone 1 is closed (step S15=NO), control unit 112 controls display unit 110 to display video constituting the TV program with screen 12 in landscape orientation (step S20). If judged to be open state information (step S15=YES), control unit 112 controls display unit 110 to display video constituting the TV program and the display information in portrait orientation, with screen 12 partitioned based on the partition ratio corresponding to the open state in partition information table T100 stored in partition storage unit 200 (step S25).

Control unit 112 outputs the TV program according to the display control on display unit 110 (step S30).

Control unit 112 judges whether a viewing end instruction has been received as the result of a key operation by the user (step S35).

Control unit 112 ends TV program output if judged that the viewing end instruction has been received (step S35=YES), and continues outputting the TV program according to the display control on display unit 110 if judged that the viewing end instruction has not been received (step S35=NO).

(2) Display Control Switching

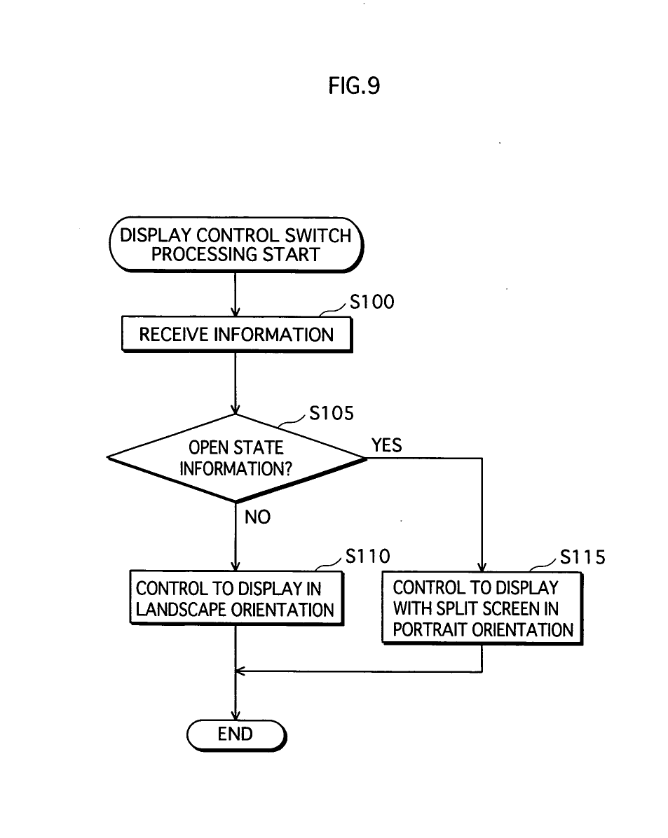

Display control switching performed by control unit 112 of mobile phone 1 to switch display controls when the open/closed state of mobile phone 1 has changed during output of the TV program (step S30 in FIG. 8) is described here using the flowchart shown in FIG. 9.

Control unit 112, on receipt of information, being one of open state information and closed state information, from operation detection unit 109 (step S100), judges whether the received information is open state information (step S105).

If judged not to be open state information, indicating that received information is closed state information (step S105=NO), control unit 112 controls display unit 110 to display video constituting the TV program with screen 12 in landscape orientation (step S110). Note that subsequent output of the TV program at step S30 in FIG. 8 is performed according to the display control changed at step S110.

If judged to be open state information (step S105=YES), control unit 112 generates display information corresponding to the current operating condition, and controls display unit 110 to display video constituting the TV program and the generated display information in portrait orientation, with screen 12 partitioned based on the partition ratio corresponding to the open state in partition information table T100 stored in partition information storage unit 101 (step S115). Note that subsequent output of the TV program at step S30 in FIG. 8 is performed according to the display control changed at step S115.

(3) Event Notification

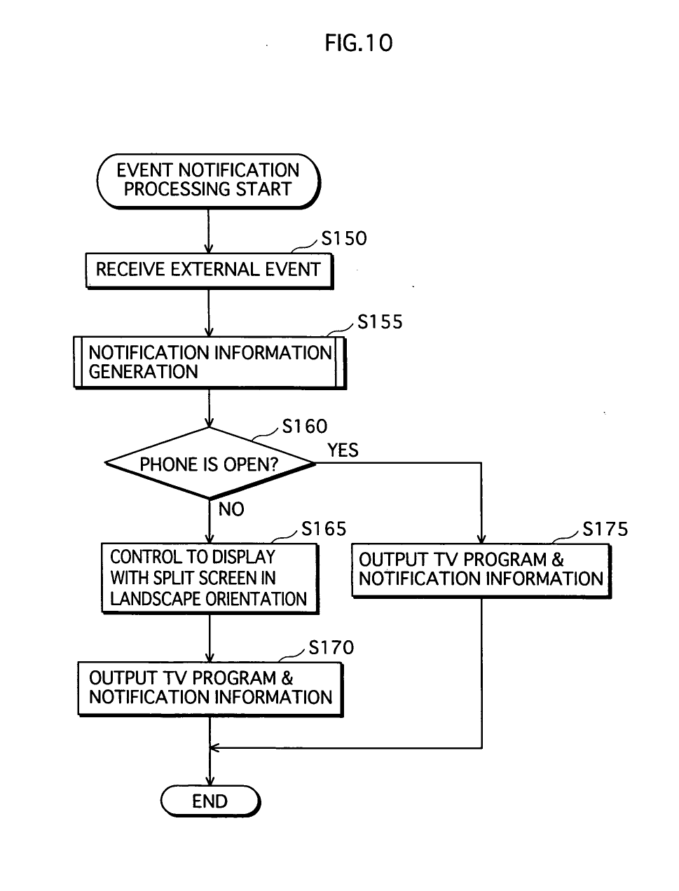

Event notification performed by control unit 112 of mobile phone 1 to notify the user of the receipt of an external event when mobile phone 1 receives an external event during output of the TV program (step S30 in FIG. 8) is described here using the flowchart shown in FIG. 10.

Control unit 112 receives an external event via wireless unit 104 (step S150). Next, control unit 112 generates notification information (step S155).

Control unit 112 judges whether the information stored in state storage unit 200 is open state information or closed state information (step S160).

If judged not to be open state information, indicating that mobile phone 1 is closed (step S160=NO), control unit 112 controls display unit 110 to display video constituting the TV program and the notification information in landscape orientation, with screen 12 partitioned based on the partition ratio corresponding to the closed state in partition information table T100 stored in partition information storage unit 101 (step S165). Next, control unit 112 outputs the video data of the TV program and the notification information to display unit 110 (step S170). Note that subsequent output of the TV program and notification information at step S30 in FIG. 8 is performed according to the display control changed at step S165.

If judged to be open state information (step S160=YES), control unit 112 outputs the video data of the TV program and the notification information as display information to display unit 110 (step S175). Note that subsequent output of the TV program and notification information at step S30 in FIG. 8 is performed according to the display control changed at step S165.

(4) Notification Information Generation

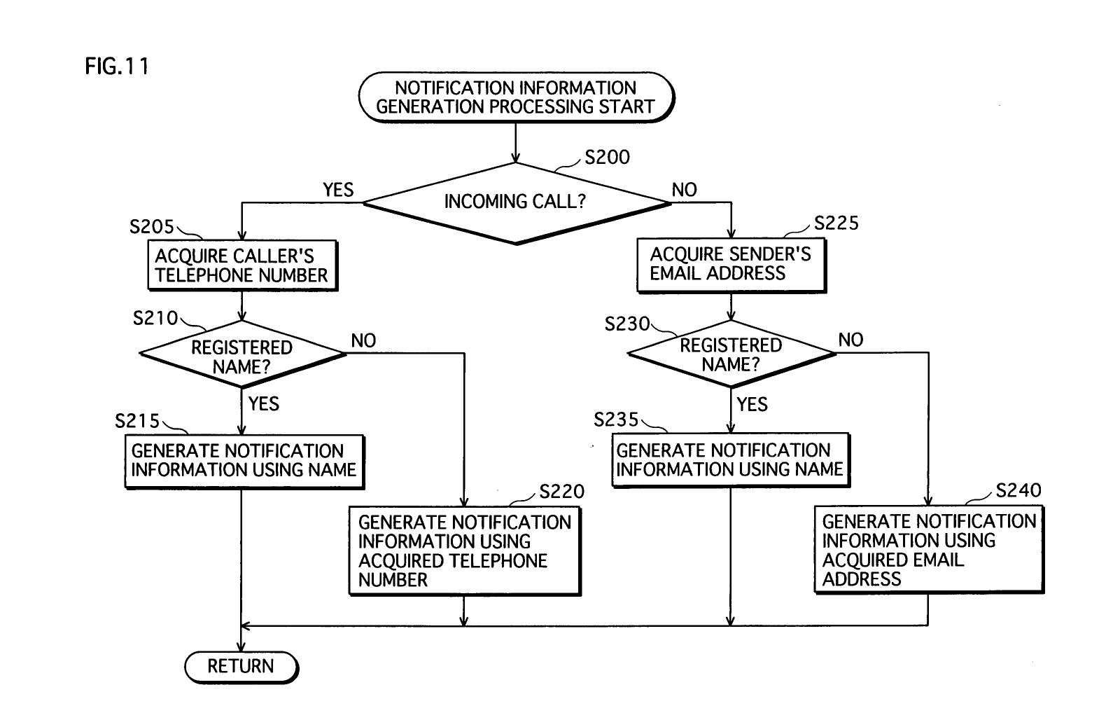

Here, notification information generation performed at step S155 of the event notification processing is described using the flowchart shown in FIG. 11.

Control unit 112 judges whether the external event is an incoming call (step S200).

If judged to be an incoming call (step S200=YES), control unit 112 acquires the originator's telephone number from information related to the received incoming call (step S205), and judges whether the name of the originator corresponding to the acquired telephone number exists in telephone book table T102 (step S210). If judged that the name exists (step S210=YES), control unit 112 uses the registered name of the originator to generate notification information notifying the user of the incoming call (step S215). If judged that the name does not exist (step S210=NO), control unit 112 uses the acquired telephone number to generate notification information notifying the user of the incoming call (step S215). Note that if the telephone number cannot be acquired due to non-notification, information indicating non-notification is used instead of a telephone number to generated notification information.

If the received event is judged to be an incoming email (step S200=NO), control unit 112 acquires the originator's email address from information related to the received incoming email (step S225), and judges whether the name of the originator corresponding to the acquired address exists in telephone book table T102 (step S230). If judged that the name exists (step S230=YES), control unit 112 uses the name of the originator to generate notification information notifying the user of the incoming call (step S235). If judged that the name does not exist (step S210=NO), control unit 112 uses the acquired email address to generate notification information notifying the user of the incoming call (step S240).

(5) Key Operation Switching

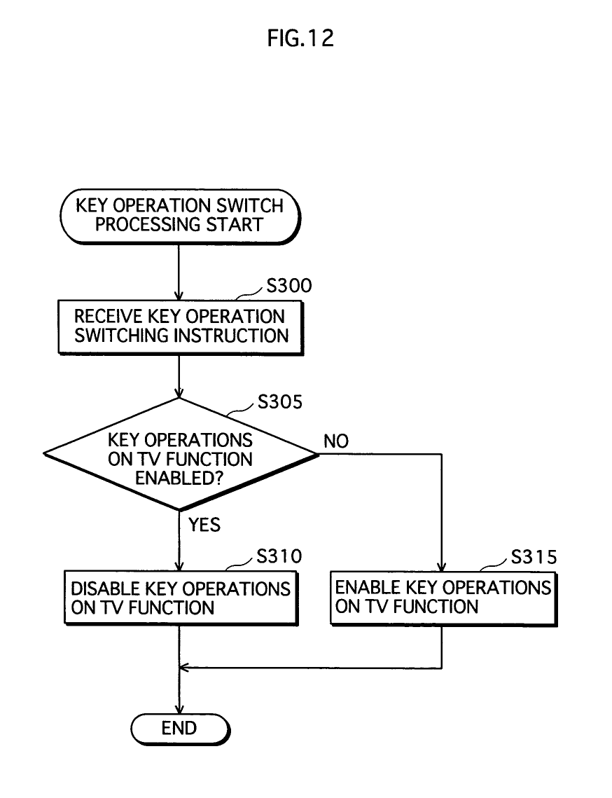

Here, key operation switching performed by control unit 112 to switch the key operation allocation during output of the TV program (step S30 in FIG. 8) with mobile phone 1 in the open state (i.e. during split-screen display in portrait orientation) is described using the flowchart shown in FIG. 12.

Control unit 112, on receipt of a key operation switching instruction as the result of a key operation by the user (step S300), judges whether key operations on the TV function are currently enabled (step S305).

If judged that key operations on the TV function are enabled (step S305=YES), control unit 112 disables the key operations on the TV function, and enables key operations on information displayed on the fourth screen 153 (step S310).

If judged that key operations on the TV function are not enabled (step S305=NO), control unit 112 enables the key operations on the TV function, and disables key operations on information displayed on fourth screen 154 (step S315).

(6) Volume Adjustment

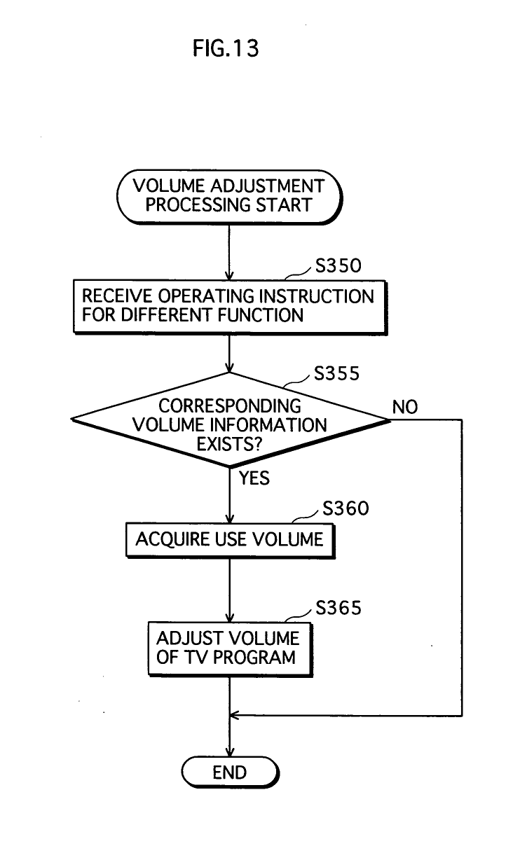

Here, volume adjustment performed by control unit 112 to adjust the TV volume in the case where mobile phone 1 receives an operating instruction for another function during output of the TV program with mobile phone 1 in the open state (i.e. during split-screen display in portrait orientation) is described using the flowchart shown in FIG. 13.

Control unit 112, on receipt of an operating instruction for another function as the result of a key operation by the user (step S350), judges whether volume information that includes a use application corresponding to the received operating instruction exists in volume information table T101 (step S355).

If judged that the relevant volume information exists (step S355=YES), control unit 112 acquires the use volume included in the volume information (step S360). Control unit 112 adjusts the audio volume of the TV program output from speakers 107 based on the acquired use volume (step S365). Note that subsequent output of the audio data of the TV program at step S30 in FIG. 8 is based on the adjusted volume. Audio constituting the TV program is not output, however, when the adjusted volume is MUTE.

If judged that the relevant volume information does not exist (step S355=NO), control unit 112 ends the processing.

4. Summary

According to the present invention as described above, mobile phone 1 is able to notify the user that an external event has been received while continuing to output a TV program without interruption, when an external event is received during TV program output.

Mobile phone 1 is also able to control the displayed screen by detecting changes in the open/closed state (i.e. the use/non-use) of mobile phone 1 during TV program output.

Mobile phone 1 is also able to switch the allocation of key operations during TV program output in the open state.

Furthermore, mobile phone 1, on receipt of an operating instruction for another function during TV program output in the open state, is able to adjust the volume of audio constituting the TV program according to the received operating instruction.

Mobile phone 1 is also able to change partition ratios pre-stored when the time mobile phone 1 is purchased, by receiving partition information.

Mobile phone 1 is also able to newly register or change volume information, by receiving volume registration information.

Note that the present invention described above based on a preferred embodiment is of course not limited to this embodiment. The following modifications are also included in the present invention.

Modifications

(1) In the above embodiment, the volume of audio constituting the TV program is adjusted in the case where an external event is received during TV program output, although the present invention is not limited to this. The volume of audio constituting the TV program may be adjusted in the case where an external event is received during TV program output.

For example, audio constituting the TV program may be muted and a sound effect (e.g. ring tone when a call is received) produced notifying the user that an event has been received.

(2) In the above embodiment, video constituting a TV program and notification information are displayed with screen 12 partitioned, in the case where an external event is received during the display of video constituting a TV program in the closed state, although the present invention is not limited to this. The notification information may be displayed as a ticker superimposed over video constituting the TV program displayed on screen 12.

For example, display may be achieved using an electrodeposited ticker. With an electrodeposited ticker, the area for displaying the ticker is set as a blue back and characters are outlined on the blue back. In this case, control unit 112 acquires the display area of the electrodeposited ticker based on the partition ratio in the closed state, converts the data in the acquired area from video data to notification information for display by electrodeposited ticker, and outputs the data converted to notification information to display unit 110. Display by electrodeposited ticker is thus made possible. Here, the display area is acquired, for example, by acquiring an address showing the display area.

(3) The present invention is not limited in terms of the method for detecting the open/closed state. Apart from the method shown in the above embodiment, the open/closed state may be detected, for example, using an optical sensor, a magnetic sensor, or an encoder.

(4) In the above embodiment, mobile phone 1 partitions screen 12 horizontally with the screen in portrait orientation, when mobile phone 1 changes from the closed to the open state during display of a TV program, although the present invention is not limited to this. The screen may be partitioned vertically while remaining in landscape orientation, when mobile phone 1 changes from the closed to the open state during display of a TV program. In this case, mobile phone 1 performs display without the 90-degree rotation of TV program display (i.e. the display orientation of the TV program is the same as before partitioning).

(5) In the above embodiment, use of mobile phone 1 is detected by detecting the open/closed state of mobile phone 1, although the present invention is not limited to this. Use of mobile phone 1 may be detected by the depressing of a button provided in key input unit 111.

For example, use of mobile phone 1 may be detected by detecting that a button provided on the side of first casing 10 or second casing 11 has been depressed. In this case, mobile phone 1, on detecting the depressing of the button during TV program output in the closed state, may partition screen 12 in landscape orientation, or may partition screen 12 horizontally in portrait orientation.

(6) In the above embodiment, mobile phone 1 is a sliding phone, although the present invention is not limited to this. The present invention may be a mobile phone that opens and closes by means other than sliding.

For example, the present invention may be a mobile phone that opens and closes by rotation, or a mobile phone that combines folding and rotation.

Also, the present invention may be a straight-type mobile phone that does not open or close. In this case, the straight-type mobile phone partitions screen 12 horizontally with the screen in portrait orientation, when the depressing of a button is detected during display of video constituting a TV program with the screen in landscape orientation. The partitioning of the screen is similar to the above embodiment in the case where an external event is received during display of video constituting a TV program.

(7) When partitioning screen 12 in the above embodiment, the partition ratio is fixed after partitioning using information stored in partition information storage unit 101, although the present invention is not limited to this. The partition ratio may be changed after partitioning as the result of a key operation, and display performed using the changed partition ratio.

In this case, corresponding information stored in partition information storage unit 101 may be overwritten with the partition ratio changed as the result of the key operation, and next time split-screen display is performed, the screen may be partitioned using the newly written partition ratio. If overwriting is not performed, screen 12 is partitioned using the information stored in partition information storage unit 101 when split-screen display is next performed.

(8) In the above embodiment, the screen is partitioned into first screen 151 and second screen 152 when an external event is received during display of video constituting a TV program in the closed state, and video constituting the TV program and notification information are displayed respectively on first screen 151 and second screen 152, although the present invention is not limited to this. The notification information may be displayed on first screen 151, and video constituting the TV program may be displayed on second screen 152.

Similarly to this display of video constituting the TV program and display information in the closed state, display information may be displayed on third screen 153 and video constituting the TV program may be displayed on fourth screen 154 in the open state.

(9) In the above embodiment, video constituting a TV program and display information are displayed on the split screen, although the present invention is not limited to this. Video resulting from a video call and display information may be displayed on the split screen. Notification information notifying the user of an incoming email can thus be displayed as display information when an incoming email is received during a video call.

Also, in the case where an incoming call related to a video call is received during display of video constituting a TV program, video resulting from the video call may be displayed on fourth screen 154. The user is thus able to watch television while taking a video call.

(10) In the above embodiment, screen 12 is partitioned horizontally (i.e. into top and bottom areas) when partitioned into first screen 151 and second screen 152, although screen 12 may be partitioned vertically (i.e. into left and right areas).

(11) In the above embodiment, video constituting a TV program and notification information are displayed with screen 12 partitioned into first screen 151 and second screen 152 in the case where an external event is received during display of video constituting a TV program in the closed state, although the present invention is not limited to this. In the case where an external event is received during display of video constituting a TV program and notification information in the closed state, screen 12 may be partitioned into third screen 153 and fourth screen 154 in portrait orientation, and video constituting the TV program and the notification information may be displayed on third screen 153 and fourth screen 154, respectively.

(12) In the above embodiment, screen 12 is rectangular in shape, with the horizontal and vertical lengths being different, although screen 12 may be square in shape.

When displaying video constituting a TV program in the closed state in this case, a rectangular portion of the square-shaped area of screen 12 is set for displaying video constituting the TV program. For example, square screen 12 may be partitioned horizontally into three rectangular areas at a ratio of “10:80:10” with the longitudinal axis of mobile phone 1 as the horizontal axis, and video constituting the TV program displayed in the middle rectangular area. Alternatively, square screen 12 may be partitioned horizontally into three rectangular areas at a ratio of “10:80:10” with the longitudinal axis of mobile phone 1 as the vertical axis, and video constituting the TV program displayed in the middle rectangular area.

Also, when displaying video constituting a TV program, square screen 12 may be partitioned horizontally in two with the longitudinal axis of mobile phone 1 as the vertical axis.

(13) In the above embodiment, mobile phone 1 switches the target of key operations after judging whether key operations on information shown on the third screen are enabled or whether key operations on information shown on the fourth screen are enabled, although the present invention is not limited to this.

Mobile phone 1 may receive a first instruction from the user to enable key operations on information shown on the third screen, or a second instruction from the user to enable key operations on information shown on the fourth screen. In this case, mobile phone 1 enables key operations on information shown on the third screen when the first instruction is received, and enables key operations on information shown on the fourth screen when the second instruction is received.

(14) The target of key operations may also be switched in the following manner.

Control unit 112 pre-stores address information showing addresses for storing operating instruction information. Functions relating to information displayed on the third screen operate based on the operating instruction information stored in addresses starting from “0”, while functions relating to information displayed on the fourth screen operate based on the operating instruction information stored in addresses starting from “1”.

Control unit 112, on receipt of switching instruction information from key input unit 111, adds “1” to the first 1-bit of the address information. Since bits are usually expressed in binary using “0” and “1”, and the carried value is disregarded even when “1” is added to the first 1-bit of the address information whenever switching instruction information is received, the first 1-bit of the address information will always be either “0” or “1”.

Control unit 112, on receipt of operating instruction information from key input unit 111, stores the operating instruction information in an address shown in the address information. In other words, control unit 112 stores the received information in an address starting from “0” or an address starting from “1”.

The target of key operations can thus be switched.

(15) The present invention is not limited in the number of areas into which the screen is partitioned. There may be three or more partitions.

(16) The present invention is not limited in terms of the communication system used. For example, the present invention may be applied in a mobile phone that uses any of the PHS (Personal Handyphone System), CDMA (Code Division Multiple Access), and PDC (Personal Digital Cellular) systems.

(17) TV programs received from a broadcast station may be analog TV programs. In this case, the mobile phone displays video constituting a TV program similarly to a normal LCD television. Note that the method of rotating the video 90 degrees is similar to the example shown in the above embodiment. The downscaling of video constituting a TV program when transferring from the closed to the open state may be performed in the following manner, for example. Using the vertical dot size when display is performed in the closed state with the screen in landscape orientation as a reference value, video constituting the TV program is downscaled based on the ratio of the reference value and the vertical dot size after downscaling, and the downscaled video is displayed.

(18) The present invention may be any of the methods shown above. Alternatively, the present invention may be computer programs that realize these methods using a computer, or digital signals composed of the computer programs.

The present invention may be a computer-readable recording medium having the computer programs or digital signals recorded thereon, examples of which include flexible disk, hard disk, CD-ROM, MO, DVD, DVD-ROM, DVD-RAM, BD (Blu-ray Disc), and semiconductor memory etc. Alternatively, the present invention may be the computer programs or digital signals recorded on any of these computer-readable recording media.

The present invention may be the computer programs or digital signals transmitted via a network or the like, typical examples of which include a telecommunications line, a wireless or cable communication line, and the Internet.

The present invention may be a computer system provided with a microprocessor and a memory, in which the memory stores the computer programs and the microprocessor operates in accordance with the computer programs.

The computer programs or digital signals may be implemented using an independent computer system by transferring the computer programs or digital signals recorded on the recording medium, or by transmitting the computer programs or digital signals via the network or the like.

(19) The present invention may be any combination of the above embodiment and modifications.

### Embodiment 2

1. Overview

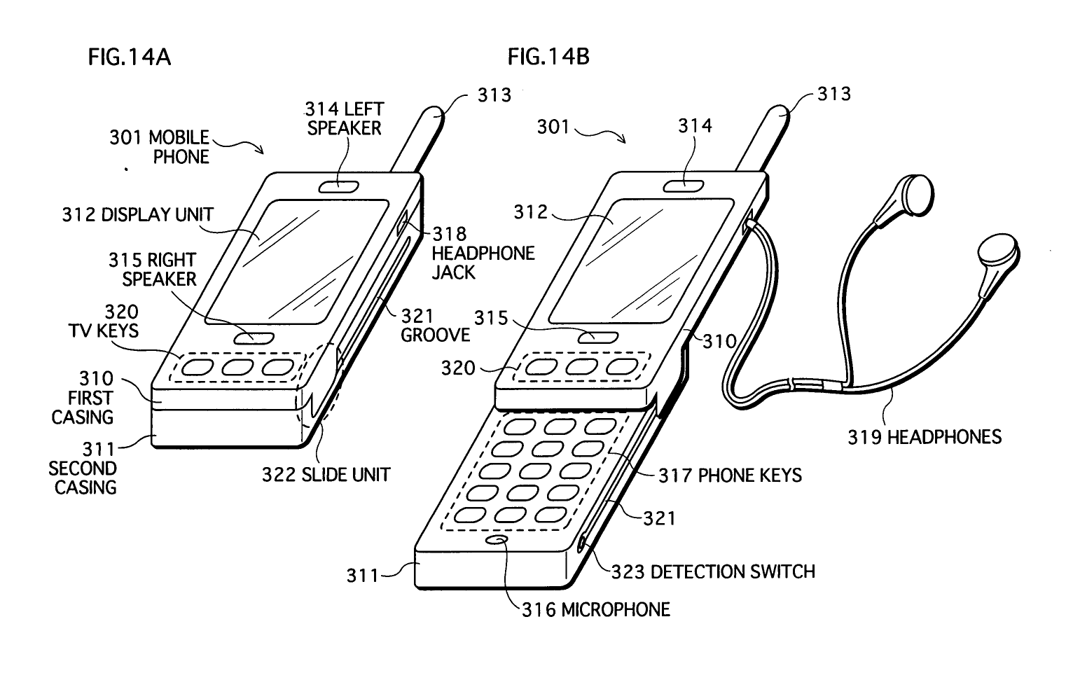

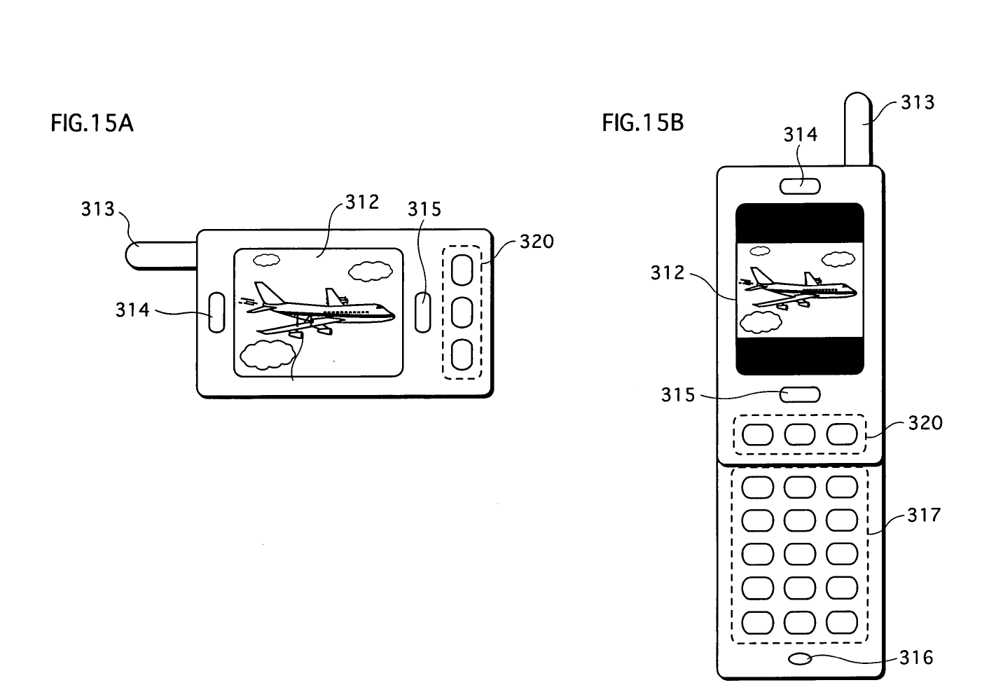

FIGS. 14A and 14B are schematics of a mobile phone 301 pertaining to embodiment 2 of the present invention.

Mobile phone 301 includes a TV function for receiving TV broadcast waves, in addition to a telephone function for conducting calls as a telephone.

The casing of mobile phone 301 is composed of a first casing 310 provided with a display unit 312, and a second casing 311 electrically connected to first casing 310.

Mobile phone 301 has a slide open/close structure. The two states that mobile phone 301 adopts are a closed state in which first casing 310 and second casing 311 entirely overlap as shown in FIG. 14A, and an open state in which first casing 310 has shifted parallel to second casing 311 as shown in FIG. 14B.

A slide unit 322, which is part of first casing 310 as shown in FIG. 14A, is provided with a projecting rail. The projecting rail meshes with a groove 321 provided in second casing 311, and slides along groove 321.

A detection switch 323 is provided at one end of groove 321, and the projecting rail depresses detection switch 323 when mobile phone 301 is closed.

Mobile phone 301 is assumed to be open when detection switch 323 is not depressed.

When using the telephone function or simple-viewing a TV broadcast, the user uses mobile phone 301 in the open state, in which the mobile phone is easy to hold and a variety of operations are available using keys and the like necessary for operating the telephone function.

Here, “simple-viewing” refers to watching a TV broadcast for a relatively short period of time, examples of which include checking the score of a live baseball broadcast, watching the news for a few minutes, or zapping around to see what shows are on at the moment.

The user uses mobile phone 301 in the closed state when watching TV for long periods of time, such as when watching a TV drama or a live baseball broadcast until the end of the game.

FIGS. 15A and 15B shows mobile phone 301 displaying a received TV broadcast on display unit 312.

FIG. 15A shows the received TV broadcast being displayed on display unit 312 with mobile phone 301 in the closed state.

FIG. 15B shows the received TV broadcast being displayed on display unit 312 with mobile phone 301 in the open state.

Display unit 312 displays information in portrait mode when mobile phone 301 is in the open state, and in landscape mode when mobile phone 301 is in the closed state.

Video broadcast from the broadcast station has a landscape aspect ratio, and mobile phone 301 performs controls to cause display unit 312 to display the video full screen, as shown in FIG. 15A.

To display landscape-oriented video with mobile phone 301 in the open state, the video is rotated 90 degrees from the state displayed on display unit 312 shown in FIG. 15A and downscaled in size before being displayed on display unit 312. In this case, full-screen display is not achieved, and the display area of the screen cannot be effectively used.

When mobile phone 301 is not in use, the user place mobile phone 301 in the closed state.

First casing 310 is provided with display unit 312, an antenna 313, a left speaker 314, a right speaker 315, a headphone jack 318, and TV keys 320.

Display unit 312 is an LCD display or the like that displays received TV broadcasts and information necessary when making calls using the telephone function.

Antenna 313 receives TV broadcast waves, with an antenna that transmits and receives radio waves for making calls using the telephone function being built-in to the casing.

Left speaker 314 is for outputting monaural audio and the left channel of stereo audio.

Right speaker 315 is for outputting the right channel of stereo audio.

TV keys 320 are a collection of the minimum keys that the user of mobile phone 301 needs to watch TV, and include a TV ON/OFF key for switching TV broadcast reception on/off, a channel key for selecting reception channels, and a volume key for adjusting TV volume.

Second casing 311 is provided with a microphone 316 and phone keys 317.

Microphone 316 collects sounds uttered by the user.

Phone keys 317 are composed of keys necessary for making a call, such as an on-hook key, an off-hook key, and a numeric keypad for inputting telephone numbers. The numeric keypad is also used when watching TV, such as for inputting channels during TV broadcast reception when the TV function is ON.

Headphones 319 can be connected to headphone jack 318, as shown in FIG. 14B.

Headphone jack 318 detects when headphones are connected thereto and removed therefrom, and also identifies whether connected headphones are stereo or monaural by the shape of the connection terminal of the headphones.

2. Structure

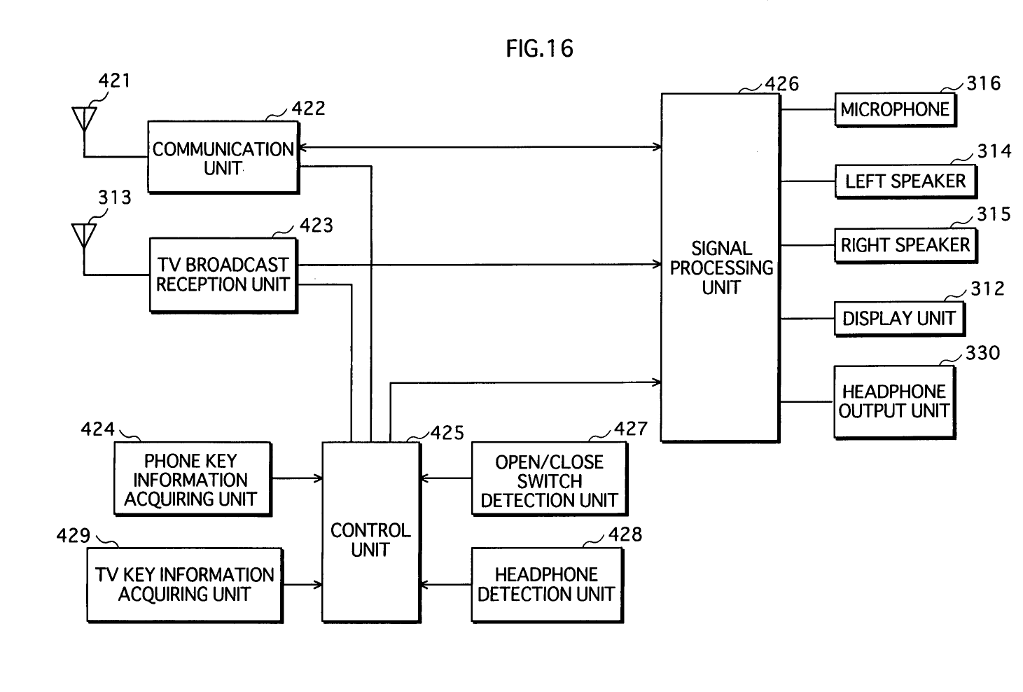

FIG. 16 is a block diagram showing an internal configuration of mobile phone 301.

Display unit 312 displays video based on red, green and blue output signals, and horizontal and vertical sync signals input from a signal-processing unit 426.

A communication unit 422 performs wireless communication for a call with a mobile-phone base station (not depicted) via an antenna 421.

Communication unit 422 transmits audio signals obtained by demodulating received signals to signal-processing unit 426.

A TV broadcast reception unit 423 is a terrestrial digital broadcast tuner composed of a tuner, a demodulator, an error corrector, a descrambler, a decommutator, a decoder, and a D/A converter etc.

TV broadcast reception unit 423 receives broadcast waves transmitted by a broadcast station (not depicted) via antenna 313, and outputs image frame information and audio signals decoded from the received broadcast waves to signal-processing unit 426.

A phone-key-information acquiring unit 424 detects that the user has depressed one of phone keys 317, and acquires phone key information corresponding to the depressed key.

Signal-processing unit 426 outputs audio signals received from communication unit 422 during a call to left speaker 314 after amplification.

Signal-processing unit 426 amplifies input audio collected by microphone 316, and transmits the amplified audio to the base station via antenna 421.

Signal-processing unit 426 causes display unit 312 to display video signals received from TV broadcast reception unit 423 in the case where the user watches a TV broadcast.

Signal-processing unit 426 outputs left and right channel signals using left speaker 314 and right speaker 315, or monaural audio obtained by combining the left and right channel signals to left speaker 314, as the result of an output control instruction from control unit 425.

Signal-processing unit 426 is provided with a VRAM (Video Random Access Memory) and a work RAM.

Signal-processing unit 426 acquires image frame information from TV broadcast reception unit 423.

Image frame information is obtained by encoding a single image, like a bitmap, for example.

Signal-processing unit 426 writes acquired image frame information to VRAM.

If instructed by control unit 425 to rotate the images 90 degree, signal-processing unit 426 uses work RAM to generate images obtained by rotating the images shown by the received image frame information 90 degrees, and expands the rotated image frame information in VRAM.

Signal-processing unit 426 outputs red, green and blue output signals and sync signals corresponding to the information in VRAM to display unit 312.

An open/close switch detection unit 427 judges that mobile phone 301 is in the closed state if detection switch 323 is depressed and in the open state if detection switch 323 is not depressed, and transmits open/close information to control unit 325 showing mobile phone 301 to be either open or closed, in the case where the TV function of mobile phone 301 is turned ON, or where mobile phone 301 changes from the closed to the open state or from the open to the closed state.

Open/close switch detection unit 427 also detects whether mobile phone 301 is open or closed when mobile phone 301 is turned on, and outputs the detection result to control unit 425 as open/close information.

A headphone detection unit 428 judges whether headphones 319 are connected to headphone jack 318 in the case where headphones 319 are connected to or removed from headphone jack 318, judges whether headphones 319 are stereo or monaural if judged to be connected, and outputs headphone information to control unit 425 showing one of “no headphones”, “stereo”, or “analog” based on the judgment result.

Headphone detection unit 428 also judges whether headphones 319 are connected and the type of connected headphones when mobile phone 301 is switch on, and transmits the judgment result to control unit 425 as headphone information.

A TV-key-information acquiring unit 429 detects the depressing of one of numeric keys 320 by the user, and acquires TV key information corresponding to the depressed key.

A headphone output unit 330 outputs audio signals output from signal-processing unit 426 to headphones 319 connected to headphone jack 318.

Control unit 425 performs audio mode judgment processing based on the open/close information acquired from open/close switch detection unit 427 and the headphone information acquired from headphone detection unit 428, and outputs the judgment result to signal-processing unit 426 as output control information.

The audio mode judgment processing is described in a later section.

Control unit 425 instructs TV broadcast reception unit 423 to perform tuning, and instructs signal-processing unit 426 to perform gain adjustment on audio output and to output video related to a TV broadcast, based on received TV key information.

Control unit 425 instructs communication unit 422 to perform wireless communication, in order to operate the telephone function, according to received TV key information.

Control unit 425 acquires headphone information and open/close information as initial values when mobile phone 301 is switched on.

3. Operations

Control unit 425 performs audio mode judgment processing when (a) the TV function changes from off to on, (b) connection or removal of headphones is detected, or (c) the open/closed state of mobile phone 301 changes.

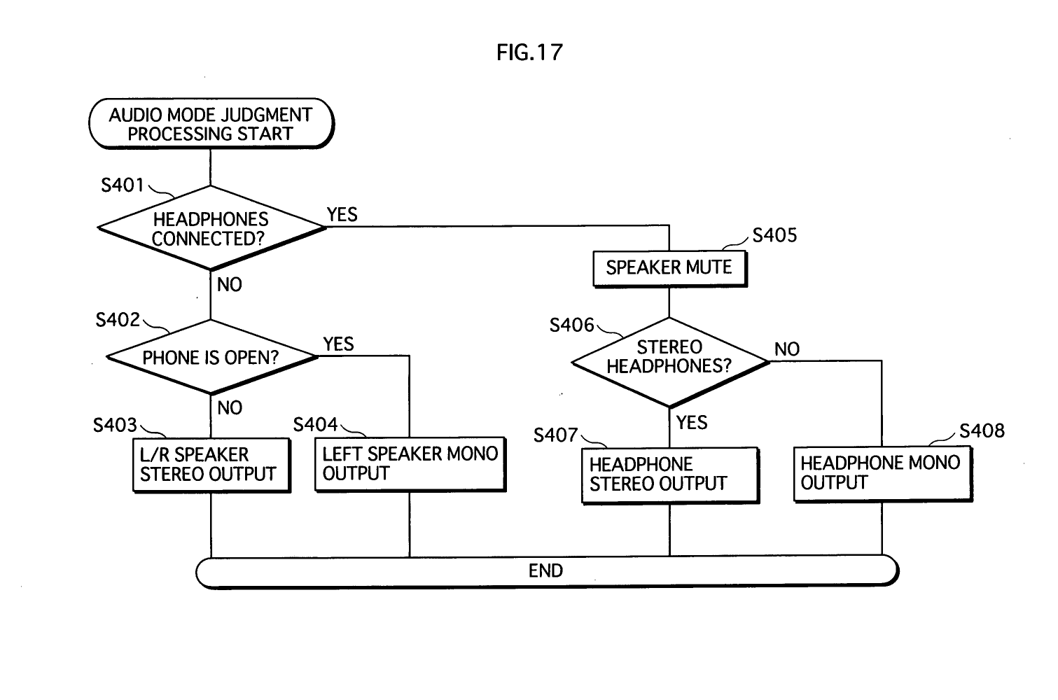

FIG. 17 is a flowchart showing audio mode judgment processing.

Control unit 425 judges whether the headphone information shows “stereo” or “mono”; that is, whether or not headphones are connected (step S401).

If the headphone information shows “no headphones” (step S401=NO), control unit 425 proceeds to S402.

If the headphone information shows “stereo” or “mono” (step S401=YES), control unit 425 transmits an output control instruction to signal-processing unit 426 showing “speaker mute” to stop audio output to left speaker 314 and right speaker 315 (step S405), and if the headphone information shows “stereo” (step S406=YES), control unit 425 transmits an output control instruction to signal-processing unit 426 showing “headphone stereo output” (step S407).

If the headphone information shows “mono” (step S406=NO), control unit 425 transmits an output control instruction to signal-processing unit 426 showing “headphone mono output” (step S408).

If the open/close information shows the open state (step S402=YES), control unit 425 output an output control instruction to signal-processing unit 426 showing “left speaker mono output” (step S404).

If the open/close information shows the closed state (step S402=NO), control unit 425 output an output control instruction to signal-processing unit 426 showing “left/right speaker stereo output” (step S403).

Note that if the telephone function is ON, control unit 425 judges whether the headphone information shows “no headphones”.

Control unit 425 transmits an output control instruction to signal-processing unit 426 showing “left speaker output” if the headphone information shows “no headphones”, and transmits an output control instruction to signal-processing unit 426 showing “headphone mono output” if the headphone information shows “mono” or “stereo”.

Signal-processing unit 426 performs audio output in accordance with output control instructions received from control unit 425.

4. Modifications

Note that the present invention described above based on a preferred embodiment is of course not limited to this embodiment.

The following modifications are also included in the present invention.

(1) The present invention is described above using an example of a mobile phone that slides open/closed, although the present invention is applicable provided that the mobile phone is structured so that the correspondence between the position of the speakers and the orientation of the video changes when the video is rotated a prescribed amount.

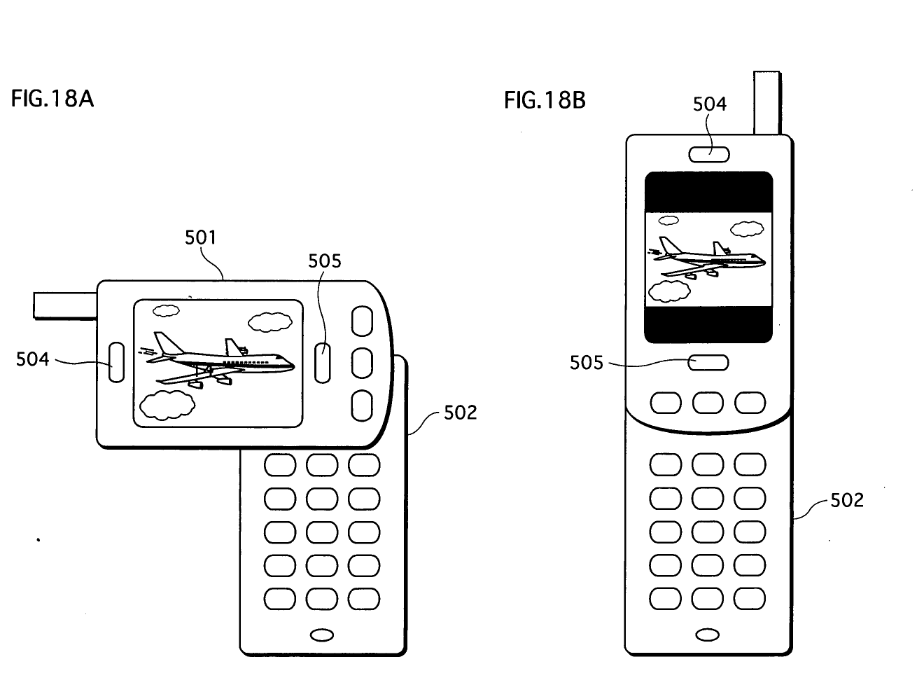

FIGS. 18A and 18B are schematics of a mobile phone with a rotating structure.

For example, the mobile phone may have a rotating structure whereby a first casing 501 rotates 90 degrees relative to a second casing 502, as shown by the mobile phone shown in FIGS. 18A and 18B.

With the mobile phone shown in FIGS. 18A and 18B, the state shown in FIG. 18A with first casing 501 rotated is equivalent to the closed state, and a left speaker 504 and a right speaker 505 output stereo audio in this state.

The state shown in FIG. 18B is equivalent to the closed state, and at least one of left speaker 504 and right speaker 505 outputs mono audio in this state after converting the stereo audio to mono.

The mobile phone may be structured to detect the orientation of the mobile phone using horizontal and vertical gyro sensors. In this case, the mobile phone may detect when the two speakers are positioned laterally relative to the display unit and when the two speakers are positioned vertically relative to the display unit as seen from the user.

(2) The present invention may be any of the methods shown above. Alternatively, the present invention may be computer programs that realize these methods using a computer, or digital signals composed of the computer programs.

The present invention may be a computer-readable recording medium having the computer programs or digital signals recorded thereon, examples of which include flexible disk, hard disk, CD-ROM, MO, DVD, DVD-ROM, DVD-RAM, BD (Blu-ray Disc), and semiconductor memory etc. Alternatively, the present invention may be the computer programs or digital signals recorded on any of these computer-readable recording media.

The present invention may be the computer programs or digital signals transmitted via a network or the like, typical examples of which include a telecommunications line, a wireless or cable communication line, and the Internet.

The present invention may be a computer system provided with a microprocessor and a memory, in which the memory stores the computer programs and the microprocessor operates in accordance with the computer programs.

The computer programs or digital signals may be implemented using an independent computer system by transferring the computer programs or digital signals recorded on the recording medium, or by transmitting the computer programs or digital signals via the network or the like.

(3) The present invention may be any combination of the above embodiment and modifications.

(4) The present invention may be a combination of embodiments 1 and 2.

For example, if the aspect ratio of the screen as seen from the user is portrait, as shown in FIG. 15b and FIG. 18b, display information related to an email or a telephone number or other information in the case of an incoming call may be displayed in addition to video, as shown in FIG. 7b.

Related Matters

A mobile phone for receiving a video signal and displaying video on a screen, includes a receiving unit operable to receive an incoming signal, an acquiring unit operable to acquire ID information identifying an originator, and a display unit operable display the acquired ID information on the screen along with the video on receipt of the incoming signal during video display on the screen.

The screen may be composed of a first display area and a second display area, and the display unit may store ratio information showing an area ratio between the first display area and the second display area, generate a downscaled image by downscaling the video based on the ratio information, and display the downscaled video in the first display area and the ID information in the second display area.

The display unit may display the ID information to overlap the video.

The mobile phone may further receive an audio signal corresponding to the video signal and output audio, and the mobile phone may further include a volume adjusting unit operable to adjust the volume of the audio output on receipt of the incoming signal, and an audio output unit operable to output or mute the audio based on the adjusted volume.

A notification method used by a mobile phone for receiving a video signal and displaying video on a screen, includes the steps of receiving a signal, acquiring ID information identifying an originator, and displaying the acquired ID information on the screen along with the video on receipt of the incoming signal during video display on the screen.

A mobile phone for receiving a video signal and displaying video on a screen, includes a detection unit operable to detect a predetermined operation by a user during video display in a standard video display orientation, a generation unit operable to generate display information according to a state of the mobile phone, being one of standby, incoming signal received, and outgoing signal transmitted, and a display unit operable, on detection of the predetermined operation by the detection unit, to generate downscaled/rotated video by downscaling and rotating the video 90 degrees from the standard video display orientation and display the generated display information on the screen alongside the downscaled/rotated video.

The screen may be composed of a first display area and a second display area, and the display unit may store ratio information showing an area ratio between the first display area and the second display area, and display the downscaled/rotated video in the first display area and the display information in the second display area.

The display unit, on receipt of ratio information different from the stored ratio information, may upscale or further downscale the downscaled/rotated video based on the received ratio information instead of displaying the generated display information alongside the downscaled/rotated video, and display the generated display information alongside the downscaled/rotated video after upscaling or further downscaling.

The mobile phone may further include an operation instruction receiving unit operable to receive an operation instruction from the user, a switching instruction receiving unit operable to receive a switching instruction to switch an operation target from the user during display of the downscaled/rotated video and the display information, and a operation switching unit operable, on receipt of the switching instruction, to switch the target of an operation based on the operation instruction from a first function relating to display of the downscaled/rotated video to a second function relating to the display information, or from the second function to the first function.

The operation switching unit may store output destination information showing one of the first function and the second function as the target of the operation based on the operation instruction, and rewrite the output destination information from information showing the first function to information showing the second function, or from information showing the second function to information showing the first function, and the operation instruction receiving unit may output the operation instruction to one of the first function and the second function according to information shown by the output destination information.

The mobile phone may further receive an audio signal corresponding to the video signal and output audio, and the mobile phone may further include an operating instruction receiving unit operable to receive an operating instruction relating to the mobile phone, a volume adjusting unit operable to adjust the volume of the audio output on receipt of the operating instruction, and an audio output unit operable to output or mute the audio based on the adjusted volume.

A display method used by a mobile phone for receiving a video signal and displaying video on a screen, includes the steps of detecting a prescribed operation by a user during video display in a standard video display orientation, generating display information according to a state of the mobile phone, being one of standby, incoming signal received, and outgoing signal transmitted, and, on detecting the predetermined operation in the detection step, generating downscaled/rotated video by downscaling and rotating the video 90 degrees from the standard video display orientation and displaying the generated display information on the screen alongside the downscaled/rotated video.

A playback method for playing a TV program in a mobile phone having two speakers disposed one on either side of a display unit, includes the steps of receiving a TV broadcast signal, displaying video in the TV broadcast signal using the display unit, and playing audio in the TV broadcast signal in stereo using the two speakers when the two speakers are positioned laterally relative to the video and in monaural using the two speakers when the two speakers are positioned vertically relative to the video.

A computer program applied in a mobile phone having two speakers disposed one on either side of a display unit, causes a computer to execute the steps of receiving a TV broadcast signal, displaying video in the TV broadcast signal using the display unit, and playing audio in the TV broadcast signal in stereo using the two speakers when the two speakers are positioned laterally relative to the video and in monaural using the two speakers when the two speakers are positioned vertically relative to the video.

### INDUSTRIAL APPLICABILITY

The technology described above is for use as the basic technology of mobile phones. These mobile phones can be manufactured and retailed by the manufacturers of information devices.

1. A mobile phone for receiving a video signal and displaying video on a screen, comprising:
an acquiring unit operable to acquire incoming signal information related to an incoming signal or detection information related to detection of a prescribed operation by a user;
a generating unit operable to generate display information related to mobile communication; and
a display unit operable to generate downscaled video by downscaling the video being displayed on the screen relative to a size of the displayed video, and display the downscaled video and the display information respectively in a first display area and a second display area obtained by partitioning the screen in two.

2. The mobile phone of claim 1, wherein
the incoming signal information includes ID information identifying an originator, and
the generating unit generates the display information based on the ID information.

3. The mobile phone of claim 2, wherein
the display unit stores ratio information showing an area ratio between the first display area and the second display area, and generates the downscaled video by downscaling the video based on the ratio information.

4. The mobile phone of claim 2, wherein
the mobile phone further receives an audio signal corresponding to the video signal, and outputs audio, and
the mobile phone further comprises:
a volume adjusting unit operable to adjust a volume of the audio output on acquiring the incoming signal information; and
an audio output unit operable to output or mute the audio based on the adjusted volume.

5. The mobile phone of claim 1, wherein
the acquiring unit acquires the detection information by detecting a prescribed operation by the user during video display in a standard video display orientation, and
the display unit venerates downscaled/rotated video as the downscaled video by downscaling and rotating the video 90 degrees from the standard video display orientation, if the detection information is acquired.

6. The mobile phone of claim 5, wherein
the display unit, on receipt of new ratio information showing an area ratio between a third display area different in size from the first display area and a fourth display area obtained by partitioning the screen in two, upscales or further downscales the downscaled/rotated video based on the received ratio information, and displays the downscaled/rotated video after upscaling or further downscaling in the third display area and the display information in the fourth display area.

7. The mobile phone of claim 5, further comprising:
an operation instruction receiving unit operable to receive an operation instruction from the user;
a switching instruction receiving unit operable to receive a switching instruction from the user to switch an operation target; and
an operation switching unit operable on receipt of the switching instruction, to switch the target of an operation based on the operation instruction, from a first function relating to display of the downscaled/rotated video to a second function relating to the display information, or from the second function to the first function.

8. The mobile phone of claim 7, wherein
the operation switching unit stores output destination information showing one of the first function and the second function as the target of the operation based on the operation instruction, and rewrites the output destination information on receipt of the switching information. from information showing the first function to information showing the second function, or from information showing the second function to information showing the first function, and
the operation instruction receiving unit outputs the operation instruction to one of the first function and the second function, according to information shown by the output destination information.

9. The mobile phone of claim 5, wherein
the mobile phone further receives an audio signal corresponding to the video signal, and outputs audio, and
the mobile phone further comprises:
an operating instruction receiving unit operable to receive an operating instruction relating to the mobile phone;
a volume adjusting unit operable to adjust the volume of the audio output on receipt of the operating instruction; and
an audio output unit operable to output or mute the audio based on the adjusted volume.

10. The mobile phone of claim 1 further comprising:
two speakers disposed one on either side of the screen; and
an audio output unit operable to play audio included in a television broadcast signal in stereo using the two speakers when the two speakers are positioned laterally relative to the video, and in monaural using the two speakers when the two speakers are positioned vertically relative to the video.

11. A display method used by a mobile phone that receives a video signal and displays video on a screen and includes an acquiring unit, a generating unit and a display unit, comprising the steps of:
using the acquiring unit to acquire incoming signal information related to an incoming signal or detection information related to detection of a prescribed operation by a user;
using the generating unit to generate display information related to mobile communication; and
using the display unit to generate downscaled video by downscaling the video being displayed on the screen relative to a size of the displayed video, and display the downscaled video and the display information respectively in a first display area and a second display area obtained by partitioning the screen in two.

12. The display method of claim 11, wherein
the incoming signal information includes ID information identifying an originator, and
the generating step generates the display information based on the ID information.

13. The display method of claim 11, wherein
the acquiring step uses the acquiring unit to acquire the detection information by detecting a prescribed operation by the user during video display in a standard video display orientation, and
the display step uses the display unit to generate downscaled/rotated video as the downscaled video by downscaling and rotating the video 90 degrees from the standard video display orientation, if the detection information is acquired.

14. The display method of claim 11, wherein
the mobile phone further includes two speakers disposed one on either side of the screen, and an audio output unit, and
the display method further comprises the step of:
using the audio output unit to play audio included in a television broadcast signal in stereo using the two speakers when the two speakers are positioned laterally relative to the video, and in monaural using the two speakers when the two speakers are positioned vertically relative to the video.

15. A computer program applied in a mobile phone that receives a video signal and displays video on a screen, and includes an acquiring unit, a generating unit and a display unit, the computer program causing a computer to execute the steps of:
using the acquiring unit to acquire incoming signal information related to an incoming signal or detection information related to detection of a prescribed operation by a user;
using the generating unit to generate display information related to mobile communication; and
using the display unit to display the incoming signal information or the display information.

16. The computer program of claim 15, wherein
the incoming signal information includes ID information identifying an originator, and
the generating step generates the display information based on the ID information.

17. The computer program of claim 15, wherein
the acquiring step uses the acquiring unit to acquire the detection information by detecting a prescribed operation by the user during video display in a standard video display orientation, and
the display step uses the display unit to generate downscaled/rotated video as the downscaled video by downscaling and rotating the video 90 degrees from the standard video display orientation, if the detection information is acquired.

18. The computer program of claim 15, wherein
the mobile phone further includes two speakers disposed one on either side of the screen, and an audio output unit, and
the computer program further causes the computer to execute the step of:
using the audio output unit to play audio included in a television broadcast signal in stereo using the two speakers when the two speakers are positioned laterally relative to the video, and in monaural using the two speakers when the two speakers are positioned vertically relative to the video.

19. (canceled)

20. (canceled)
